(19) United States
(12) Patent Application Publication
(10) Pub. No.: US 2021/0405329 A1
(43) Pub. Date: Dec. 30, 2021

(54) OPTICAL SYSTEM, LENS MODULE, AND ELECTRONIC DEVICE

(71) Applicant: JIANGXI JINGCHAO OPTICAL CO., LTD., Nanchang (CN)

(72) Inventors: Xuwen DANG, Nanchang (CN); Binbin LIU, Nanchang (CN); Ming LI, Nanchang (CN); Hairong ZOU, Nanchang (CN)

(21) Appl. No.: 17/468,152

(22) Filed: Sep. 7, 2021

Related U.S. Application Data
(63) Continuation of application No. PCT/CN2020/072016, filed on Jan. 14, 2020.

(51) Int. Cl. G02B 13/00; G02B 9/64; G02B 27/00

(52) U.S. Cl. CPC G02B 13/0045; G02B 27/0025; G02B 9/64

(57) ABSTRACT

An optical system includes, in order from an object side to an image side along an optical axis, first to seventh lenses. The fifth lens has a refractive power. The fifth lens has an object-side surface which is concave near a periphery of the object-side surface of the fifth lens, and an image-side surface which is convex near a periphery of the image-side surface (S10) of the fifth lens. The sixth lens has a refractive power. The sixth lens has an object-side surface which is concave near a periphery of the object-side surface of the sixth lens, and an image-side surface which is convex near a periphery of the image-side surface of the the sixth lens. The seventh lens has a negative refractive power. The seventh lens has an object-side surface which is convex near the optical axis, and an image-side surface which is concave near the optical axis.

### CROSS-REFERENCE TO RELATED APPLICATIONS

The present application is a continuation of International Application No. PCT/CN2020/072016, filed on Jan. 14, 2020, the disclosure of which is hereby incorporated by reference in its entirety.

### TECHNICAL FIELD

The present disclosure relates to the field of optical imaging technology, and particularly to an optical system, a lens module, and an electronic device.

### BACKGROUND

With the development of science and technology, smart phones and smart electronic devices have gradually become popular, and devices with diversified camera functions have been widely favored by people. At the same time, with the upgrading of people's consumption concept, higher requirements are put forward for the lightness and thinness of mobile devices, the night shooting ability of camera equipment, and higher imaging quality. An existing lens usually has the F-number (FNO) of 2.2 or more, a thickness of less than 6 mm, and a certain small size, but it is difficult to further improve the resolution. Due to the limitation in FNO, a good shooting effect is very dependent on ambient light.

### SUMMARY

According to the present disclosure, an optical system, a lens module, and an electronic device are provided. The optical system has advantages of a large aperture, and lightness and thinness.

Technical solutions are provided blow to achieve at least one objective of the present disclosure.

In a first aspect, an optical system is provided. The optical system includes, in order from an object side to an image side along an optical axis, a first lens with a positive refractive power, a second lens with a negative refractive power, a third lens with a positive refractive power, a fourth lens with a refractive power, a fifth lens with a refractive power, a sixth lens with a refractive power, and a seventh lens with a negative refractive power. The first lens has an object-side surface which is convex, and an image-side surface which is concave near the optical axis. The second lens has an object-side surface which is convex near the optical axis, and an image-side surface which is concave. The third lens has an object-side surface which is convex.

The fourth lens has an object-side surface which is convex near the optical axis, and an image-side surface which is convex near the optical axis. The fifth lens has an object-side surface which is concave near a periphery of the object-side surface of the fifth lens, and an image-side surface which is convex near a periphery of the image-side surface of the fifth lens, and where both the object-side surface and the image-side surface of the fifth lens are aspherical. The sixth lens has an object-side surface which is concave near a periphery of the object-side surface of the sixth lens, and an image-side surface which is convex near a periphery of the image-side surface of the the sixth lens, and where both the object-side surface and the image-side surface of the sixth lens are aspherical, at least one of the object-side surface and the image-side surface of the sixth lens has at least one inflection point. The seventh lens has an object-side surface which is convex near the optical axis, and an image-side surface which is concave near the optical axis, and where both the object-side surface and the image-side surface of the seventh lens are aspherical, at least one of the object-side surface and the image-side surface of the seventh lens has at least one inflection point.

The optical system of the present disclosure has a seven-element lens structure, where aspheric structures are adopted, and inflection points are added. As such, aberrations can be eliminated, the total length of the optical system can be shortened, and appropriate distribution of refractive powers is provided. The structure of the optical system can be designed flexibly to achieve a large aperture, lightness and thinness, high resolution, and high imaging quality. An aperture stop with a large diameter is adopted, and thus the optical system can have the minimum FNO of 1.4 (that is, f/1.4), which is smaller than a FNO (for example, 2.0 and more) of the existing lens group, such that the amount of incident light can be increased and the imaging quality is improved.

In an implementation, the optical system satisfies the following expression: 1.4≤f/EPD≤2.0. f represents an effective focal length of the optical system, EPD represents an entrance pupil diameter of the optical system. When the above expression is satisfied, it is possible to ensure that a sufficient amount of incident light enters the optical system and avoid vignetting around an image plane. Further, when f/EPD≤1.7, sufficient incident light can improve the shooting effect in a dark ambience. On the other hand, decreasing F-number will lead to a smaller Airy disk, and in turn lead to a greater limit of resolution. In this implementation, in combination with an appreciate distribution of the refractive powers of the lenses, high resolution and high imaging quality can be achieved.

In an implementation, the optical system satisfies the following expression: 1.3<TTL/ImgH<1.7. TTL represents a distance from the object-side surface of the first lens to an image plane on the optical axis, ImgH represents half of a diagonal length of an effective pixel region on the image plane. When the above expression is satisfied, the lenses can support a high-pixel electronic photosensitive chip. A shortened TTL allows the entire imaging lens group to be shortened, which is beneficial to achieving ultra-thin and miniaturization. In this implementation, in combination with an appropriate distribution of the surface shapes and the refractive powers of the lenses, it is possible to maintain the compactness and good imaging quality.

In an implementation, the optical system satisfies the following expression: 0.9<SD11/SD31<1.3. SD11 represents half of a clear aperture of the object-side surface of the first lens, SD31 represents half of a clear aperture of the object-side surface of the third lens. When the above expression is satisfied, a reduction in the sizes of the first lens, the second lens, and the third lens which are in the head of the optical system is beneficial to realizing a miniaturized design of the head of the optical system, while improving the illuminance of the image plane, providing an appropriate light deflection angle, and reducing the sensitivity of the optical system.

In an implementation, the optical system satisfies the following expression: |f/f4|≤0.30. f represents an effective focal length of the optical system, f4 represents an effective focal length of the fourth lens. A positive or negative refractive power of the fourth lens, which is used as a part to adjust the total refractive power of the optical system, forms a symmetrical structure with the first lens, second lens, and third lens in the head of the optical system, which can balance a distortion occurred in the head of the optical system and avoid high-order aberrations sue to an excessive refractive index.

In an implementation, the optical system satisfies the following expression: |f6/R61|<10.0. f6 represents an effective focal length of the sixth lens, R61 represents a radius of curvature of the object-side surface of the sixth lens near the optical axis. The sixth lens includes at least one inflection point, which can effectively correct aberrations generated by the first to fifth lenses, and enhance the resolution.

In an implementation, the optical system satisfies the following expression: 0.50≤CT4+T45/CT5+CT6≤0.81. CT4 represents a thickness of the fourth lens on the optical axis, T45 represents a distance from the fourth lens to the fifth lens on the optical axis, CT5 represents a thickness of the fifth lens on the optical axis, and CT6 represents a thickness of the sixth lens on the optical axis. When the above expression is satisfied, the thicknesses and lens spacings of the fourth lens, the fifth lens, and the sixth lens on the optical axis are appropriate, which effectively improves the compactness of the lens structure and facilitates lens molding and assembly.

In an implementation, the optical system satisfies the following expression: 0.22≤|R71−R72|/|R71+R72|<0.8. R71 represents a radius of curvature of the object-side surface of the seventh lens near the optical axis, R72 represents a radius of curvature of the image-side surface of the seventh lens near the optical axis. When the above expression is satisfied, it is beneficial to correcting aberrations generated by a large aperture optical system, so that there is a uniform distribution of the refractive powers in the direction perpendicular to the optical axis, and the distortions and aberrations generated by the first to sixth lenses are significantly corrected. At the same time, excessive bending of the seventh lens is avoided, which is beneficial to molding and manufacturing.

In an implementation, the optical system satisfies the following expression: R22/R31<1.3. R22 represents a radius of curvature of the image-side surface of the second lens near the optical axis, R31 represents a radius of curvature of the object-side surface of the third lens near the optical axis. When the above expression is satisfied, R22 cooperates with R31 to reduce the reflection of light on the surface of the lens, illuminance and imaging quality are improved, and the influence of stray light is avoided.

In a second aspect, a lens module is further provided. The lens module includes the optical system according to any of the implementations in the first aspect. The optical system of the present disclosure is disposed in the lens module, such that the lens module has the advantages of a large aperture, lightness and thinness, and high imaging quality.

In a third aspect, an electronic device is further provided. The electronic device includes a housing and the lens module in the second aspect, where the lens module is received in the housing. The lens module of the present disclosure is disposed in the electronic device, the lens module has the advantages of a large aperture, high imaging quality, and lightness and thinness, such that images with good imaging quality can be shot in a low-light ambience.

### BRIEF DESCRIPTION OF THE DRAWINGS

To describe the technical solutions in the implementations of the present disclosure or the related art more clearly, the following briefly introduces the accompanying drawings required for describing the implementations or the related art. Apparently, the accompanying drawings in the following description illustrate some implementations of the present disclosure. Those of ordinary skill in the art may also obtain other drawings based on these accompanying drawings without creative efforts.

FIG. 1a is a schematic structural view of an optical system according to an implementation.

FIG. 1b illustrates a longitudinal spherical aberration curve, an astigmatic field curve, and a distortion curve of the optical system of FIG. 1a.

FIG. 2a is a schematic structural view of an optical system according to an implementation.

FIG. 2b illustrates a longitudinal spherical aberration curve, an astigmatic field curve, and a distortion curve of the optical system of FIG. 2a.

FIG. 3a is a schematic structural view of an optical system according to an implementation.

FIG. 3b illustrates a longitudinal spherical aberration curve, an astigmatic field curve, and a distortion curve of the optical system of FIG. 3a.

FIG. 4a is a schematic structural view of an optical system according to an implementation.

FIG. 4b illustrates a longitudinal spherical aberration curve, an astigmatic field curve, and a distortion curve of the optical system of FIG. 4a.

FIG. 5a is a schematic structural view of an optical system according to an implementation.

FIG. 5b illustrates a longitudinal spherical aberration curve, an astigmatic field curve, and a distortion curve of the optical system of FIG. 5a.

FIG. 6a is a schematic structural view of an optical system according to an implementation.

FIG. 6b illustrates a longitudinal spherical aberration curve, an astigmatic field curve, and a distortion curve of the optical system of FIG. 6a.

FIG. 7a is a schematic structural view of an optical system according to an implementation.

FIG. 7b illustrates a longitudinal spherical aberration curve, an astigmatic field curve, and a distortion curve of the optical system of FIG. 7a.

### DETAILED DESCRIPTION OF ILLUSTRATED IMPLEMENTATIONS

Technical solutions in the implementations of the present disclosure will be described clearly and completely hereinafter with reference to the accompanying drawings in the implementations of the present disclosure. Apparently, the described implementations are merely some rather than all implementations of the present disclosure. All other implementations obtained by those of ordinary skill in the art based on the implementations of the present disclosure without creative efforts shall fall within the protection scope of the present disclosure.

A lens module is provided. The lens module includes a lens barrel and an optical system provided in implementations of the disclosure. First to seventh lenses of the optical system are received in the lens barrel. The lens module can be an independent lens of a digital camera or an imaging module integrated on an electronic device such as a smart phone. The optical system provided in the implementations of the present disclosure is disposed the lens module, such that the lens module has advantages of a large aperture, high imaging quality, and lightness and thinness.

An electronic device is further provided. The electronic device includes a housing and the lens module in the implementations of the present disclosure. The lens module is received in the housing. In an implementation, the electronic device further includes an electronic photosensitive element. A photosensitive surface of the electronic photosensitive element serves as an image plane of the optical system. The photosensitive surface is configured to convert light passing through the first to sixth lenses and incident on the electronic photosensitive element into an electrical signal of an image. The electronic photosensitive element may be a complementary metal oxide semiconductor (CMOS) or a charge-coupled device (CCD). The electronic device can be a smart phone, a personal digital assistant (PDA), a tablet computer, a smart watch, a drone, an e-book reader, a driving recorder, a wearable device, etc. In the present disclosure, the lens module is installed in the electronic device, such that the lens module has advantages of a large aperture, high imaging quality, and lightness and thinness.

The implementations of the present disclosure provide an optical system including a first lens, a second lens, a third lens, a fourth lens, a fifth lens, a sixth lens, and a seventh lens. The first to seventh lenses are arranged in order from an object side to an image side along an optical axis of the optical system. In the first to seventh lenses, there is an air gap between any two adjacent lenses.

The first lens has an object-side surface which is convex, and an image-side surface which is concave in a vicinity of the optical axis. The second lens has an object-side surface which is convex in a vicinity of the optical axis, and an image-side surface which is concave. The third lens has an object-side surface which is convex. The fourth lens has an object-side surface which is convex in a vicinity of the optical axis, and an image-side surface which is convex in a vicinity of the optical axis. The fifth lens has an object-side surface which is concave near a periphery of the object-side surface of the fifth lens, and an image-side surface which is convex near a periphery of the image-side surface of the fifth lens, and where both the object-side surface and the image-side surface of the fifth lens are aspherical. The sixth lens has an object-side surface which is concave near a periphery of the object-side surface of the sixth lens, and an image-side surface which is convex near a periphery of the image-side surface of the the sixth lens, and where both the object-side surface and the image-side surface of the sixth lens are aspherical, at least one of the object-side surface and the image-side surface of the sixth lens has at least one inflection point. The seventh lens has an object-side surface which is convex in a vicinity of the optical axis, and an image-side surface which is concave in a vicinity of the optical axis, and where both the object-side surface and the image-side surface of the seventh lens are aspherical, at least one of the object-side surface and the image-side surface of the seventh lens has at least one inflection point.

The optical system further includes a stop. The stop can be arranged at any position between the first to seventh lenses. In an implementation, the stop is disposed to a side of the object-side surface of the first lens.

The optical system of the present disclosure has a seven-element lens structure, where aspheric structures are adopted, and inflection points are added. As such, aberrations can be eliminated, the total length of the optical system can be shortened, and appropriate distribution of refractive powers is provided. The structure of the optical system can be designed flexibly to achieve a large aperture, lightness and thinness, high resolution, and high imaging quality. An aperture stop with a large diameter is adopted, and thus the optical system can have the minimum FNO of 1.4 (that is, f/1.4), which is smaller than a FNO (for example, 2.0 and more) of the existing lens group, such that the amount of incident light can be increased and the imaging quality is improved.

In an implementation, the optical system satisfies the following expression: 1.4≤f/EPD≤2.0. f represents an effective focal length of the optical system, EPD represents an entrance pupil diameter of the optical system.

In this implementation, the stop is positioned in the front of the optical system. That is, the stop is d positioned to a side of the object-side surface of the first lens. The entrance pupil serves as the light entrance of the optical system and the entrance pupil diameter is substantially the same as the diameter of the stop. When the above expression is satisfied, it is possible to ensure that a sufficient amount of incident light enters the optical system and avoid vignetting around an image plane. Further, when f/EPD≤1.7, sufficient incident light can improve the shooting effect in a dark ambience. On the other hand, decreasing F-number will lead to a smaller Airy disk, and in turn lead to a greater limit of resolution. In this implementation, in combination with an appreciate distribution of the refractive powers of the lenses, high resolution and high imaging quality can be achieved.

In an implementation, the optical system satisfies the following expression: 1.3<TTL/ImgH<1.7. TTL represents a distance from the object-side surface of the first lens to an image plane on the optical axis, ImgH represents half of a diagonal length of an effective pixel region on the image plane.

In this implementation, ImgH represents the half-image height. ImgH determines the size of the electronic photosensitive chip. A greater ImgH leads to a larger size of the maximum electronic photosensitive chip that can be supported. When the above expression is satisfied, the lenses can support a high-pixel electronic photosensitive chip. A shortened TTL allows the entire imaging lens group to be shortened, which is beneficial to achieving ultra-thin and miniaturization. In this implementation, in combination with an appropriate distribution of the surface shapes and the refractive powers of the lenses, it is possible to maintain the compactness and good imaging quality.

In an implementation, the optical system satisfies the following expression: 0.9<SD11/SD31<1.3. SD11 represents half of a clear aperture of the object-side surface of the first lens, SD31 represents half of a clear aperture of the object-side surface of the third lens.

In this implementation, if SD11/SD31≤0.9, SD31 is significantly larger than SD11, it is difficult to control aberrations and image surface illuminance for edge light rays. If SD11/SD31≥1.3, it is easy to cause excessive deflection angles of edge light rays, resulting in an increased sensitivity of the optical system. When the above expression is satisfied, a reduction in the sizes of the first lens, the second lens, and the third lens which are in the head of the optical system is beneficial to realizing a miniaturized design of the head of the optical system, while improving the illuminance of the image plane, providing an appropriate light deflection angle, and reducing the sensitivity of the optical system.

In an implementation, the optical system satisfies the following expression: |f/f4|≤0.30. f represents an effective focal length of the optical system, f4 represents an effective focal length of the fourth lens.

In this implementation, a positive or negative refractive power of the fourth lens, which is used as a part to adjust the total refractive power of the optical system, forms a symmetrical structure with the first lens, second lens, and third lens in the head of the optical system, which can balance a distortion occurred in the head of the optical system and avoid high-order aberrations sue to an excessive refractive index.

In an implementation, the optical system satisfies the following expression: |f6/R61|<10.0. f6 represents an effective focal length of the sixth lens, R61 represents a radius of curvature of the object-side surface of the sixth lens at its region in a vicinity of the optical axis.

In this implementation, the sixth lens includes at least one inflection point, which can effectively correct aberrations generated by the first to fifth lenses, and enhance the resolution.

In an implementation, the optical system satisfies the following expression: 0.50≤CT4+T45/CT5+CT6≤0.81. CT4 represents a thickness of the fourth lens on the optical axis, T45 represents a distance from the fourth lens to the fifth lens on the optical axis, CT5 represents a thickness of the fifth lens on the optical axis, and CT6 represents a thickness of the sixth lens on the optical axis.

In this implementation, an appropriate design in the above-identified thickness and distance will directly affect moldability or manufacturability of lens. When the above expression is satisfied, the thicknesses and lens spacings of the fourth lens, the fifth lens, and the sixth lens on the optical axis are appropriate, which effectively improves the compactness of the lens structure and facilitates lens molding and assembly.

In an implementation, the optical system satisfies the following expression: 0.22≤|R71−R72|/|R71+R72|<0.8. R71 represents a radius of curvature of the object-side surface of the seventh lens at its region in a vicinity of the optical axis, R72 represents a radius of curvature of the image-side surface of the seventh lens at its region in a vicinity of the optical axis.

In this implementation, when the above expression is satisfied, it is beneficial to correcting aberrations generated by a large aperture optical system, so that there is a uniform distribution of the refractive powers in the direction perpendicular to the optical axis, and the distortions and aberrations generated by the first to sixth lenses are significantly corrected. At the same time, excessive bending of the seventh lens is avoided, which is beneficial to molding and manufacturing.

In an implementation, the optical system satisfies the following expression: R22/R31<1.3. R22 represents a radius of curvature of the image-side surface of the second lens at its region in a vicinity of the optical axis, R31 represents a radius of curvature of the object-side surface of the third lens at its region in a vicinity of the optical axis.

In this implementation, when the above expression is satisfied, R22 cooperates with R31 to reduce the reflection of light on the surface of the lens, illuminance and imaging quality are improved, and the influence of stray light is avoided.

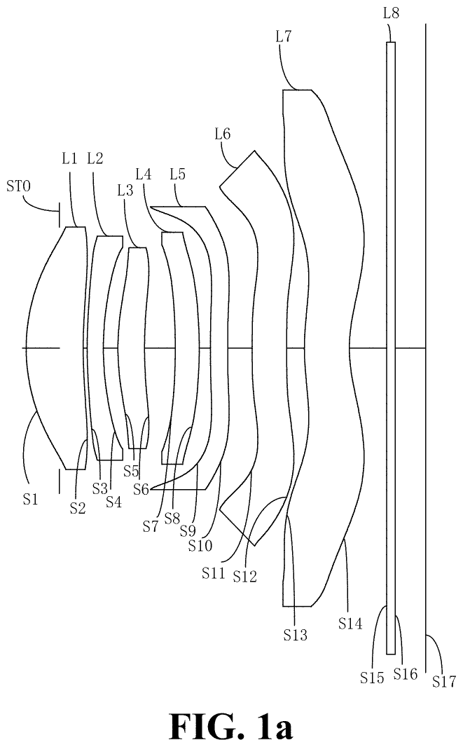

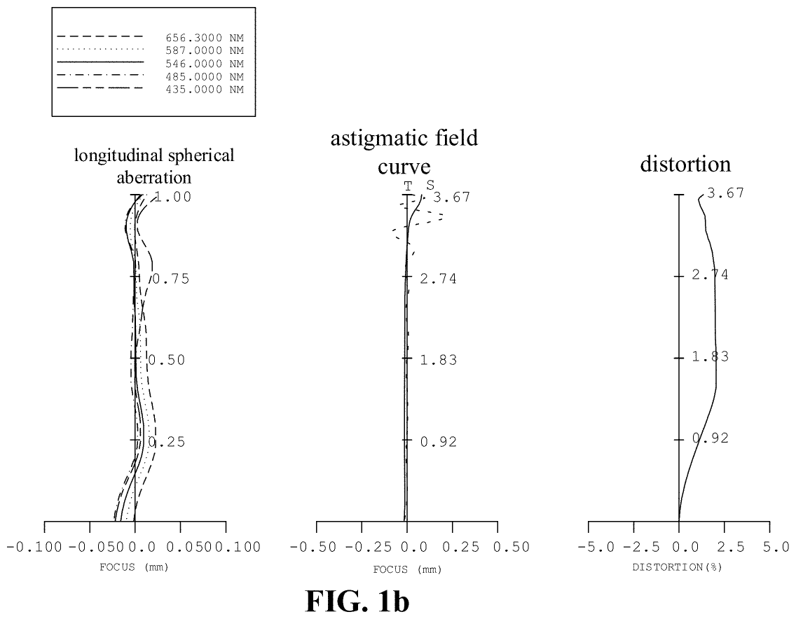

Referring to FIG. 1a and FIG. 1b, the optical system in this implementation includes, in order from the object side to the image side along the optical axis, the first lens L1, the second lens L2, the third lens L3, the fourth lens L4, the fifth lens L5, the sixth lens L6, and the seventh lens L7.

The first lens L1 has a positive refractive power. The object-side surface S1 of the first lens L1 is convex near the optical axis and a periphery of the object-side surface S1 of the first lens L1. The image-side surface S2 of the first lens L1 is concave near the the optical axis and is convex near a periphery of the image-side surface S2 of the first lens L1.

The second lens L2 has a negative refractive power. The object-side surface S3 of the second lens L2 is convex near the optical axis and a periphery of the object-side surface S3 of the second lens L2. The image-side surface S4 of the second lens L2 is concave near the optical axis and a periphery of the image-side surface S4 of the second lens L2.

The third lens L3 has a positive refractive power. The object-side surface S5 of the third lens L3 is convex near the optical axis and a periphery of the object-side surface of the third lens L3. The image-side surface S6 of the third lens L3 is concave near the optical axis and is convex near a periphery of the image-side surface S6 of the third lens L3.

The fourth lens L4 has a positive refractive power. The object-side surface S7 of the fourth lens L4 is concave near the optical axis and a periphery of the object-side surface S7 of the fourth lens L4. The image-side surface S8 of the fourth lens L4 is convex near the optical axis and a periphery of the image-side surface S8 of the fourth lens L4.

The fifth lens L5 has a negative refractive power. The object-side surface S9 of the fifth lens L5 is convex near the optical axis and is concave near a periphery of the object-side surface S9 of the fifth lens L5. The image-side surface S10 of the fifth lens L5 is concave near the optical axis and is convex near a periphery of the image-side surface S10 of the fifth lens L5.

The sixth lens L6 has a negative refractive power. The object-side surface S11 of the sixth lens L6 is convex near the optical axis and is concave near a periphery of the object-side surface S11 of the sixth lens L6. The image-side surface S12 of the sixth lens L6 is concave near the optical axis and is convex near a periphery of image-side surface S12 of the sixth lens L6.

The seventh lens L7 has a negative refractive power. The object-side surface S13 of the seventh lens L7 is convex near the optical axis and is concave near a periphery of the object-side surface S13 of the seventh lens L7. The image-side surface S14 of the seventh lens L7 is concave near the optical axis and is convex near a periphery of image-side surface S14 of the seventh lens L7.

In an implementation, each lens of the first to seventh lenses (L1 to L7) is made of plastic.

In addition, the optical system further includes a stop (ST0), an infrared cut-off filter L8, and an image plane S17. The ST0 is disposed to a side of the object-side surface the first lens L1 (i.e., a side of the first lens L1 away from the second lens L2) for controlling the amount of incident light. In other implementations, the stop ST0 can be disposed between two adjacent lenses. Alternatively, the stop ST0 can be disposed on any of the other lenses. The infrared cut-off filter L8 is disposed at an image side of the seventh lens L7 and has an object-side surface S15 and an image-side surface 516. The infrared cut-off filter L8 is used to filter out infrared light so that the light entering the image plane S17 is visible light, and the wavelength of visible light is 380 nm-780 nm. The infrared cut-off filter L8 is made of glass and can be coated thereon. The image plane S17 is an effective pixel area of the electronic photosensitive element.

Table 1a illustrates characteristics of the optical system in this implementation. Data in Table 1a is obtained based on light with a wavelength of 546 nm. Each of Y radius, thickness, and focal length is in units of 4 millimeter (mm).

TABLE 1a
Optical system of FIG. 1a
f = 4.35, FNO = 1.59, FOV = 77.12, TTL = 5.20

| Surface | Surface | | | Thick- | | Refractive | Abbe | Focal |
|---|---|---|---|---|---|---|---|---|
| Number | Name | Shape | Y Radius | ness | Material | Index | Number | length |
| Object | | Spherical | Infinity | Infinity | | | | |
| number | | | | | | | | |
| ST0 | Stop | Spherical | Infinity | −0.429 | | | | |
| S1 | First | Aspherical | 1.840 | 0.742 | Plastic | 1.544 | 55.912 | 4.85 |
| S2 | lens | Aspherical | 5.155 | 0.051 | | | | |
| S3 | Second | Aspherical | 4.767 | 0.210 | Plastic | 1.661 | 20.412 | −8.45 |
| S4 | lens | Aspherical | 2.540 | 0.190 | | | | |
| S5 | Third | Aspherical | 2.257 | 0.346 | Plastic | 1.544 | 55.912 | 8.76 |
| S6 | lens | Aspherical | 4.039 | 0.400 | | | | |
| S7 | Fourth | Aspherical | −6.622 | 0.314 | Plastic | 1.544 | 55.912 | 15.98 |
| S8 | lens | Aspherical | −3.829 | 0.146 | | | | |
| S9 | Fifth | Aspherical | Infinity | 0.225 | Plastic | 1.661 | 20.412 | |
| S10 | lens | Aspherical | Infinity | 0.317 | | | | |
| S11 | Sixth | Aspherical | Infinity | 0.448 | Plastic | 1.544 | 55.912 | |
| S12 | lens | Aspherical | Infinity | 0.232 | | | | |
| S13 | Seventh | Aspherical | 2.383 | 0.585 | Plastic | 1.544 | 55.912 | −7.35 |
| S14 | lens | Aspherical | 1.366 | 0.486 | | | | |
| S15 | Infrared | Spherical | Infinity | 0.110 | Glass | 1.517 | 64.167 | |
| S16 | cut−off | Spherical | Infinity | 0.396 | | | | |
| | filter | | | | | | | |
| S17 | Image | Spherical | Infinity | 0.000 | | | | |
| | plane | | | | | | | |

Note:
The reference wavelength is 546 nm

f represents an effective focal length of the optical system. FNO represents F-number of the optical system. FOV represents an angle of view of the optical system. TTL represents a distance from the object-side surface of the first lens L1 to the image plane S17 of the optical system on the optical axis.

In this implementation, the object-side surface and the image-side surface of each of the first to seventh lenses (L1, L2, L3, L4, L5, L6, L7) are aspherical. A surface shape of each aspherical lens can be defined by but not limited to the following aspherical formula:

$$x = \frac{{ch}^{2}}{1 + \sqrt{1 - ( k + 1 ) {c}^{2} {h}^{2}}} + \sum {Aih}^{i}$$

x represents a distance (sag) along the optical axis from a vertex of the aspherical surface to a position on the aspherical surface at a height h. c represents the paraxial curvature of the aspherical surface, and is the inverse of the Y radius (that is, c=1/R, where R represents the Y radius in the Table 1a). k represents the conic coefficient. Ai represents the i-th order correction coefficient of the aspherical surface. Table 1b shows higher-order coefficients A4, A6, A8, A10, A12, A14, A15, A17, and A18 of each of aspherical lens surfaces S1 to S14 in the optical system of FIG. 1a.

TABLE 1b
Optical system of FIG. 1a
Aspherical coefficients

| | Surface Number | | | | | | |
|---|---|---|---|---|---|---|---|
| | S1 | S2 | S3 | S4 | S5 | S6 | S7 |
| K | −1.3694E+00 | −4.9319E+00 | −4.5799E+00 | −5.0126E−01 | −2.2088E+00 | −2.2088E+00 | 1.0164E+01 |
| A4 | 1.9734E−02 | −7.8552E−02 | −1.4298E−01 | −1.4275E−01 | −9.5225E−02 | −9.5225E−02 | 1.6581E−02 |
| A6 | 2.5948E−02 | 1.2560E−01 | 3.4204E−01 | 3.3295E−01 | 9.3895E−02 | 9.3895E−02 | −9.5382E−02 |
| A8 | −8.9422E−02 | −6.1193E−03 | −3.7203E−01 | −4.9684E−01 | −1.5225E−01 | −1.5225E−01 | 6.2992E−02 |
| A10 | 1.8493E−01 | −5.2192E−01 | −1.0598E−01 | 5.1518E−01 | 8.1415E−02 | 8.1415E−02 | 2.8041E−01 |
| A12 | −2.4691E−01 | 1.0087E+00 | 7.4154E−01 | −4.6235E−01 | 8.7286E−02 | 8.7286E−02 | −1.0175E+00 |
| A14 | 2.0900E−01 | −9.3307E−01 | −8.7697E−01 | 4.6693E−01 | −2.1547E−01 | −2.1547E−01 | 1.4826E+00 |
| A16 | −1.0879E−01 | 4.8217E−01 | 5.2524E−01 | −4.0613E−01 | 1.6479E−01 | 1.6479E−01 | −1.1514E+00 |
| A18 | 3.1268E−02 | −1.3398E−01 | −1.6437E−01 | 2.1285E−01 | −4.1584E−02 | −4.1584E−02 | 4.8011E−01 |
| A20 | −3.7757E−03 | 1.5605E−02 | 2.1155E−02 | −4.6252E−02 | −7.3450E−04 | −7.3450E−04 | −8.5758E−02 |
| | Surface Number | | | | | | |
| | S8 | S9 | S10 | S11 | S12 | S13 | S14 |
| K | 2.4824E+00 | 0.0000E+00 | 0.0000E+00 | 0.0000E+00 | 0.0000E+00 | −3.6414E+00 | −6.3284E+00 |
| A4 | 2.1892E−01 | 4.1004E−01 | 4.2290E−01 | 4.2290E−01 | 2.7014E−01 | −2.3086E−01 | −9.6083E−02 |
| A6 | −9.1590E−01 | −1.6700E+00 | −1.4821E+00 | −1.4821E+00 | −3.4528E−01 | 1.3904E−01 | 3.6131E−02 |
| A8 | 2.2413E+00 | 3.4105E+00 | 2.5429E+00 | 2.5429E+00 | 2.3368E−01 | −8.9879E−02 | −1.2616E−02 |
| A10 | −3.5916E+00 | −4.4677E+00 | −2.7700E+00 | −2.7700E+00 | −1.0879E−01 | 4.5478E−02 | 2.3716E−03 |
| A12 | 3.8127E+00 | 3.8586E+00 | 1.9808E+00 | 1.9808E+00 | 3.5751E−02 | −1.4219E−02 | 4.8031E−05 |
| A14 | −2.7012E+00 | −2.2136E+00 | −9.3202E−01 | −9.3202E−01 | −8.2591E−03 | 2.6812E−03 | −1.0670E−04 |
| A16 | 1.2446E+00 | 8.1416E−01 | 2.7864E−01 | 2.7864E−01 | 1.2955E−03 | −2.9930E−04 | 1.9493E−05 |
| A18 | −3.3696E−01 | −1.7338E−01 | −4.7907E−02 | −4.7907E−02 | −1.2425E−04 | 1.8248E−05 | −1.5209E−06 |
| A20 | 4.0329E−02 | 1.6142E−02 | 3.5931E−03 | 3.5931E−03 | 5.4454E−06 | −4.6848E−07 | 4.5138E−08 |

FIG. 1b illustrates a longitudinal spherical aberration curve, an astigmatic field curve, and a distortion curve of the optical system of FIG. 1a. The longitudinal spherical aberration curve represents a focus deviation of each of light rays with different wavelengths after passing through each lens of the optical system. The astigmatic field curve represents tangential field curvature and sagittal field curvature. The distortion curve represents magnitudes of distortions corresponding to different field angles. As illustrated in FIG. 1b, the optical system of FIG. 1a can achieve good imaging quality.

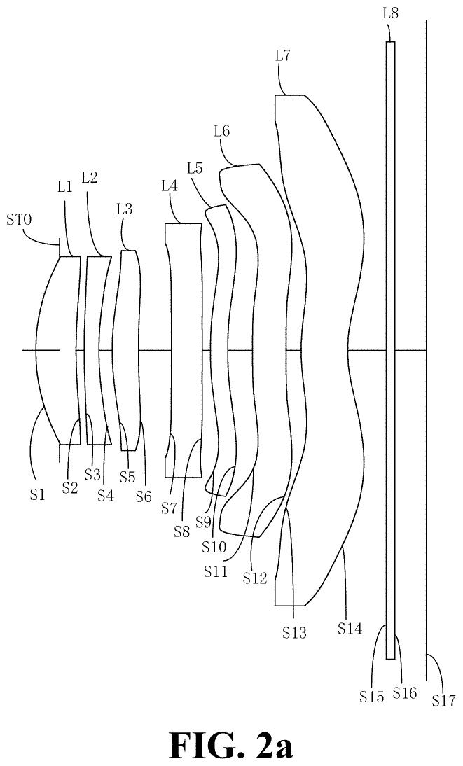

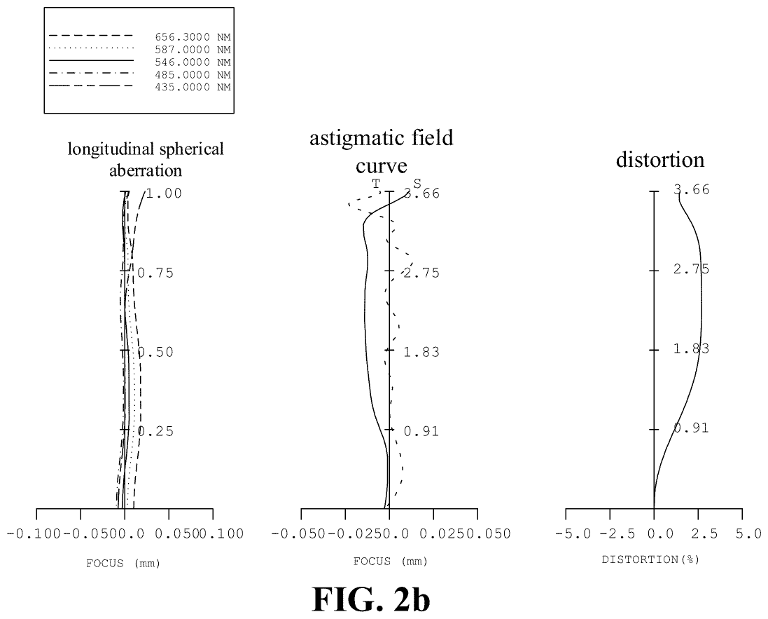

Referring to FIG. 2a and FIG. 2b, the optical system in this implementation includes, in order from the object side to the image side along the optical axis, the first lens L1, the second lens L2, the third lens L3, the fourth lens L4, the fifth lens L5, the sixth lens L6, and the seventh lens L7.

The first lens L1 has a positive refractive power. The object-side surface S1 of the first lens L1 is convex near the optical axis and a periphery of the object-side surface S1 of the first lens L1. The image-side surface S2 of the first lens L1 is concave near the the optical axis and is convex near a periphery of the image-side surface S2 of the first lens L1.

The second lens L2 has a positive refractive power. The object-side surface S3 of the second lens L2 is convex near the optical axis and a periphery of the object-side surface S3 of the second lens L2. The image-side surface S4 of the second lens L2 is concave near the optical axis and a periphery of the image-side surface S4 of the second lens L2.

The third lens L3 has a positive refractive power. The object-side surface S5 of the third lens L3 is convex near the optical axis and a periphery of the object-side surface of the third lens L3. The image-side surface S6 of the third lens L3 is concave near the optical axis and is convex near a periphery of the image-side surface S6 of the third lens L3.

The fourth lens L4 has a negative refractive power. The object-side surface S7 of the fourth lens L4 is concave near the optical axis and a periphery of the object-side surface S7 of the fourth lens L4. The image-side surface S8 of the fourth lens L4 is convex near the optical axis and is concave near a periphery of the image-side surface S8 of the fourth lens L4.

The fifth lens L5 has a positive refractive power. The object-side surface S9 of the fifth lens L5 is convex near the optical axis and is concave near a periphery of the object-side surface S9 of the fifth lens L5. The image-side surface S10 of the fifth lens L5 is concave near the optical axis and is convex near a periphery of the image-side surface S10 of the fifth lens L5.

The sixth lens L6 has a negative refractive power. The object-side surface S11 of the sixth lens L6 is concave near the optical axis and a periphery of the object-side surface S11 of the sixth lens L6. The image-side surface S12 of the sixth lens L6 is convex near the optical axis and a periphery of image-side surface S12 of the sixth lens L6.

The seventh lens L7 has a negative refractive power. The object-side surface S13 of the seventh lens L7 is convex near the optical axis and is concave near a periphery of the object-side surface S13 of the seventh lens L. The image-side surface S14 of the seventh lens L7 is concave near the optical axis and is convex near a periphery of image-side surface S14 of the seventh lens L7.

The other structures of the optical system of FIG. 2a are identical with the optical system of FIG. 1a, reference can be made to the optical system of FIG. 1a.

Table 2a illustrates characteristics of the optical system in this implementation. Data in Table 2a is obtained based on light with a wavelength of 546 nm. Each of Y radius, thickness, and focal length is in units of 1 millimeter (mm).

TABLE 2a
Optical system of FIG. 2a
f = 4.15 , FNO = 2.0, FOV = 79.8, TTL = 5.00

| Surface | Surface | | | Thick- | | Refractive | Abbe | Focal |
|---|---|---|---|---|---|---|---|---|
| Number | Name | Shape | Y Radius | ness | Material | Index | Number | length |
| Object | | Spherical | Infinity | Infinity | | | | |
| number | | | | | | | | |
| ST0 | Stop | Spherical | Infinity | −0.303 | | | | |
| S1 | First | Aspherical | 1.808 | 0.515 | Plastic | 1.544 | 55.912 | 4.81 |
| S2 | lens | Aspherical | 5.197 | 0.102 | | | | |
| S3 | Second | Aspherical | 6.233 | 0.190 | Plastic | 1.661 | 20.412 | −8.11 |
| S4 | lens | Aspherical | 2.864 | 0.170 | | | | |
| S5 | Third | Aspherical | 2.635 | 0.335 | Plastic | 1.544 | 55.912 | 7.64 |
| S6 | lens | Aspherical | 6.823 | 0.423 | | | | |
| S7 | Fourth | Aspherical | −206.855 | 0.394 | Plastic | 1.544 | 55.912 | 43.14 |
| S8 | lens | Aspherical | −21.178 | 0.104 | | | | |
| S9 | Fifth | Aspherical | 4.391 | 0.222 | Plastic | 1.661 | 20.412 | 81.11 |
| S10 | lens | Aspherical | 4.681 | 0.317 | | | | |
| S11 | Sixth | Aspherical | −99.729 | 0.429 | Plastic | 1.544 | 55.912 | 365.31 |
| S12 | lens | Aspherical | −66.606 | 0.193 | | | | |
| S13 | Seventh | Aspherical | 1.961 | 0.594 | Plastic | 1.544 | 55.912 | −8.89 |
| S14 | lens | Aspherical | 1.247 | 0.494 | | | | |
| S15 | Infrared | Spherical | Infinity | 0.110 | Glass | 1.517 | 64.167 | |
| S16 | cut−off | Spherical | Infinity | 0.404 | | | | |
| | filter | | | | | | | |
| S17 | Image | Spherical | Infinity | 0.000 | | | | |
| | plane | | | | | | | |

Note:
The reference wavelength is 546 nm

Each parameter in Table 2a represents the same meaning as that in the optical system of FIG. 1a.

Table 2b shows higher-order coefficients that can be used for each aspherical lens surface in the optical system of FIG. 2a, where a shape of each aspherical lens surface can be defined by the formula given in the optical system of FIG. 1a.

TABLE 2b
Optical system of FIG. 2a
Aspherical coefficients

| | Surface Number | | | | | | |
|---|---|---|---|---|---|---|---|
| | S1 | S2 | S3 | S4 | S5 | S6 | S7 |
| K | −1.5476E+00 | −4.0374E+00 | −7.4619E+00 | −7.6559E−01 | −1.7902E+00 | −7.7952E+00 | 9.9000E+01 |
| A4 | 2.6223E−02 | −2.2533E−02 | −7.3821E−02 | −8.5547E−02 | −4.5909E−02 | −2.5154E−02 | −4.9164E−03 |
| A6 | 3.0416E−02 | −3.6867E−02 | 4.6948E−02 | 7.2862E−02 | −7.8541E−02 | −4.0527E−02 | 1.0289E−01 |
| A8 | −1.7384E−01 | 1.7455E−01 | 1.0759E−01 | 9.8120E−02 | 3.8225E−01 | −6.9651E−02 | −7.4183E−01 |
| A10 | 5.4137E−01 | −5.7726E−01 | −5.9048E−01 | −6.1662E−01 | −1.2589E+00 | 3.5239E−01 | 2.1547E+00 |
| A12 | −1.0335E+00 | 1.0372E+00 | 1.2337E+00 | 1.3214E+00 | 2.3111E+00 | −8.8009E−01 | −3.7510E+00 |
| A14 | 1.2045E+00 | −1.0905E+00 | −1.4019E+00 | −1.5116E+00 | −2.5773E+00 | 1.1596E+00 | 4.0779E+00 |
| A16 | −8.3684E−01 | 6.6470E−01 | 9.1248E−01 | 9.7211E−01 | 1.7203E+00 | −8.3179E−01 | −2.7097E+00 |
| A18 | 3.1416E−01 | −2.1548E−01 | −3.1678E−01 | −3.1933E−01 | −6.1707E−01 | 3.0909E−01 | 1.0104E+00 |
| A20 | −4.8612E−02 | 2.8586E−02 | 4.5176E−02 | 3.9749E−02 | 8.9923E−02 | −4.6740E−02 | −1.6289E−01 |
| | Surface Number | | | | | | |
| | S8 | S9 | S10 | S11 | S12 | S13 | S14 |
| K | 9.8056E+01 | 0.0000E+00 | 0.0000E+00 | 0.0000E+00 | 0.0000E+00 | −4.1455E+00 | −5.6973E+00 |
| A4 | 1.9519E−01 | 3.1948E−01 | 3.3583E−01 | 4.5683E−01 | 2.7844E−01 | −2.3995E−01 | −9.9726E−02 |
| A6 | −5.7437E−01 | −1.0896E+00 | −1.0497E+00 | −8.5193E−01 | −3.5831E−01 | 1.1351E−01 | 2.8545E−02 |
| A8 | 9.0472E−01 | 1.7999E+00 | 1.5121E+00 | 9.0432E−01 | 2.2538E−01 | −5.5600E−02 | −4.2202E−03 |
| A10 | −9.3220E−01 | −1.9318E+00 | −1.3279E+00 | −7.2716E−01 | −9.1520E−02 | 2.7037E−02 | −7.5923E−04 |
| A12 | 6.2260E−01 | 1.4009E+00 | 7.3052E−01 | 4.3551E−01 | 2.5680E−02 | −8.7336E−03 | 5.3596E−04 |
| A14 | −2.6791E−01 | −7.1121E−01 | −2.5125E−01 | −1.8160E−01 | −5.2766E−03 | 1.7098E−03 | −1.2039E−04 |
| A16 | 7.9958E−02 | 2.4936E−01 | 5.2314E−02 | 4.7904E−02 | 8.0428E−04 | −1.9767E−04 | 1.4353E−05 |
| A18 | −1.7455E−02 | −5.4305E−02 | −6.0540E−03 | −7.0057E−03 | −8.0634E−05 | 1.2461E−05 | −9.1562E−07 |
| A20 | 2.0821E−03 | 5.4329E−03 | 3.0406E−04 | 4.2771E−04 | 3.7630E−06 | −3.3040E−07 | 2.4570E−08 |

FIG. 2b illustrates a longitudinal spherical aberration curve, an astigmatic field curve, and a distortion curve of the optical system of FIG. 2a. In this implementation, the longitudinal spherical aberration curve represents deviations of focus points of lights of different wavelengths after passing through the lenses of the optical system. The astigmatic field curve represents a tangential field curvature and a sagittal field curvature. The distortion curve represents distortion values corresponding to different angles of view. As illustrated in FIG. 2b, the optical system of FIG. 2a can achieve good imaging quality.

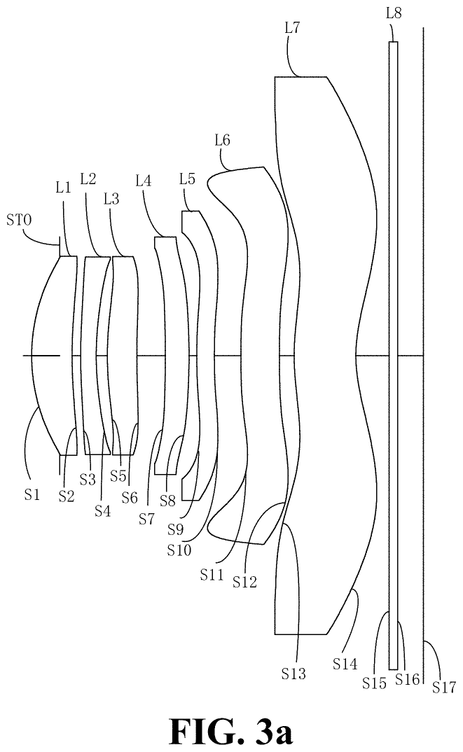

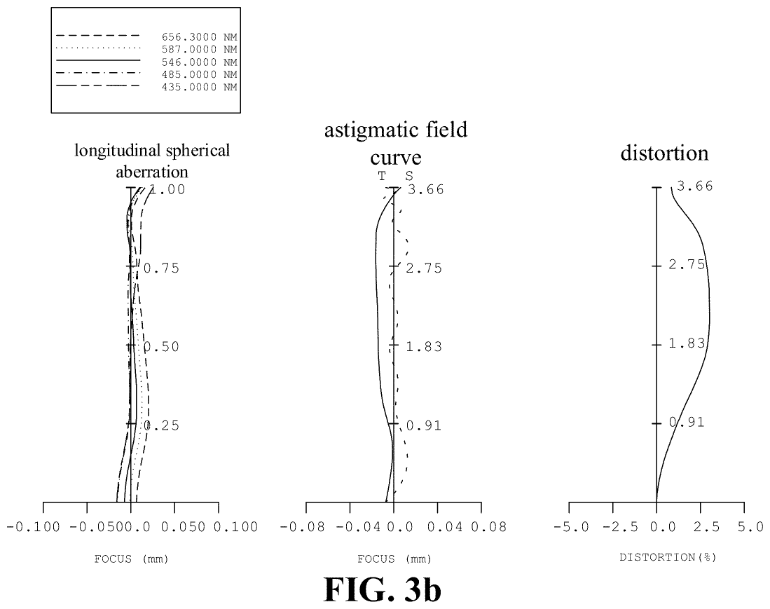

Referring to FIG. 3a and FIG. 3b, the optical system in this implementation includes, in order from the object side to the image side along the optical axis, the first lens L1, the second lens L2, the third lens L3, the fourth lens L4, the fifth lens L5, the sixth lens L6, and the seventh lens L7.

The first lens L1 has a positive refractive power. The object-side surface S1 of the first lens L1 is convex near the optical axis and a periphery of the object-side surface S1 of the first lens L1. The image-side surface S2 of the first lens L1 is concave near the the optical axis and is convex near a periphery of the image-side surface S2 of the first lens L1.

The second lens L2 has a negative refractive power. The object-side surface S3 of the second lens L2 is convex near the optical axis and a periphery of the object-side surface S3 of the second lens L2. The image-side surface S4 of the second lens L2 is concave near the optical axis and a periphery of the image-side surface S4 of the second lens L2.

The third lens L3 has a positive refractive power. The object-side surface S5 of the third lens L3 is convex near the optical axis and is concave near a periphery of the object-side surface S5 of the third lens L3. The image-side surface S6 of the third lens L3 is concave near the optical axis and is convex near a periphery of the image-side surface S6 of the third lens L3.

The fourth lens L4 has a positive refractive power. The object-side surface S7 of the fourth lens L4 is concave near the optical axis and a periphery of the object-side surface S7 of the fourth lens L4. The image-side surface S8 of the fourth lens L4 is convex near the optical axis and a periphery of the image-side surface S8 of the fourth lens L4.

The fifth lens L5 has a negative refractive power. The object-side surface S9 of the fifth lens L5 is convex near the optical axis and is concave near a periphery of the object-side surface S9 of the fifth lens L5. The image-side surface S10 of the fifth lens L5 is concave near the optical axis and is convex near a periphery of the image-side surface S10 of the fifth lens L5.

The sixth lens L6 has a negative refractive power. The object-side surface S11 of the sixth lens L6 is convex near the optical axis and is concave near a periphery of the object-side surface S11 of the sixth lens L6. The image-side surface S12 of the sixth lens L6 is concave near the optical axis and is convex near a periphery of image-side surface S12 of the sixth lens L6.

The seventh lens L7 has a negative refractive power. The object-side surface S13 of the seventh lens L7 is convex near the optical axis and is concave near a periphery of the object-side surface S13 of the seventh lens L7. The image-side surface S14 of the seventh lens L7 is concave near the optical axis and is convex near a periphery of image-side surface S14 of the seventh lens L7.

The other structures of the optical system of FIG. 3a are identical with the optical system of FIG. 1a, reference can be made to the optical system of FIG. 1a.

Table 3a illustrates characteristics of the optical system in this implementation. Data in Table 3a is obtained based on light with a wavelength of 587.6 nm. Each of Y radius, thickness, and focal length is in units of millimeter (mm).

TABLE 3a
Optical system of FIG. 3a
f = 3.99, FNO = 1.8, FOV = 82.20, TTL = 5.03

| Surface | Surface | | | Thick- | | Refractive | Abbe | Focal |
|---|---|---|---|---|---|---|---|---|
| Number | Name | Shape | Y Radius | ness | Material | Index | Number | length |
| Object | | Spherical | Infinity | Infinity | | | | |
| number | | | | | | | | |
| ST0 | Stop | Spherical | Infinity | −0.358 | | | | |
| S1 | First | Aspherical | 1.786 | 0.518 | Plastic | 1.544 | 55.912 | 4.89 |
| S2 | lens | Aspherical | 4.836 | 0.111 | | | | |
| S3 | Second | Aspherical | 5.628 | 0.200 | Plastic | 1.661 | 20.412 | −9.80 |
| S4 | lens | Aspherical | 2.984 | 0.143 | | | | |
| S5 | Third | Aspherical | 3.287 | 0.377 | Plastic | 1.544 | 55.912 | 9.61 |
| S6 | lens | Aspherical | 8.433 | 0.368 | | | | |
| S7 | Fourth | Aspherical | −12.930 | 0.304 | Plastic | 1.544 | 55.912 | 15.56 |
| S8 | lens | Aspherical | −5.171 | 0.101 | | | | |
| S9 | Fifth | Aspherical | 11.333 | 0.224 | Plastic | 1.661 | 20.412 | −125.53 |
| S10 | lens | Aspherical | 9.905 | 0.342 | | | | |
| S11 | Sixth | Aspherical | 140.313 | 0.494 | Plastic | 1.544 | 55.912 | −331.23 |
| S12 | lens | Aspherical | 78.942 | 0.189 | | | | |
| S13 | Seventh | Aspherical | 2.425 | 0.793 | Plastic | 1.544 | 55.912 | −9.32 |
| S14 | lens | Aspherical | 1.453 | 0.426 | | | | |
| S15 | Infrared | Spherical | Infinity | 0.110 | Glass | 1.517 | 64.167 | |
| S16 | cut−off | Spherical | Infinity | 0.331 | | | | |
| | filter | | | | | | | |
| S17 | Image | Infinity | 0.000 | | | | | |
| | Spherical | | | | | | | |
| | plane | | | | | | | |

Note:
The reference wavelength is 546 nm

Each parameter in Table 3a represents the same meaning as that in the optical system of FIG. 1a.

Table 3b shows higher-order coefficients that can be used for each aspherical lens surface in the optical system of FIG. 3a, where a shape of each aspherical lens surface can be defined by the formula given in the optical system of FIG. 1a.

TABLE 3b
Optical system of FIG. 3a
Aspherical coefficients

| | Surface Number | | | | | | |
|---|---|---|---|---|---|---|---|
| | S1 | S2 | S3 | S4 | S5 | S6 | S7 |
| K | −1.4256E+00 | −4.7352E+00 | −7.0246E+00 | −2.8331E−01 | −2.0418E+00 | −3.7163E+00 | 3.0643E+01 |
| A4 | 2.6251E−02 | −2.8968E−02 | −7.7699E−02 | −7.2484E−02 | −4.1623E−02 | −2.4170E−02 | −1.4145E−03 |
| A6 | 2.9586E−02 | −9.6223E−03 | 7.6573E−02 | 8.4605E−02 | −4.1608E−02 | −6.6920E−02 | 2.4458E−02 |
| A8 | −1.1386E−01 | 3.3952E−03 | −1.5853E−01 | −1.1108E−01 | 1.5172E−01 | 1.8692E−01 | −4.1361E−01 |
| A10 | 2.4571E−01 | 6.1400E−02 | 4.5950E−01 | 2.4174E−01 | −5.3934E−01 | −6.5192E−01 | 1.3140E+00 |
| A12 | −3.0137E−01 | −2.3646E−01 | −9.1796E−01 | −5.0154E−01 | 9.9738E−01 | 1.3478E+00 | −2.3329E+00 |
| A14 | 1.8763E−01 | 3.6738E−01 | 1.1090E+00 | 6.6287E−01 | −1.1757E+00 | −1.7772E+00 | 2.4800E+00 |
| A16 | −3.2842E−02 | −2.9297E−01 | −7.6279E−01 | −4.9730E−01 | 8.3374E−01 | 1.4189E+00 | −1.5728E+00 |
| A18 | −2.2313E−02 | 1.1795E−01 | 2.7659E−01 | 2.0565E−01 | −2.9988E−01 | −6.1002E−01 | 5.5884E−01 |
| A20 | 8.8479E−03 | −1.8907E−02 | −4.1209E−02 | −3.7211E−02 | 3.9690E−02 | 1.0720E−01 | −8.7125E−02 |
| | Surface Number | | | | | | |
| | S8 | S9 | S10 | S11 | S12 | S13 | S14 |
| K | 5.3668E+00 | 0.0000E+00 | 0.0000E+00 | 0.0000E+00 | 0.0000E+00 | −4.1436E+00 | −5.3781E+00 |
| A4 | 2.5710E−01 | 3.9470E−01 | 3.4756E−01 | 3.6065E−01 | 2.0791E−01 | −1.6099E−01 | −6.3068E−02 |
| A6 | −1.0640E+00 | −1.5718E+00 | −1.1896E+00 | −6.4336E−01 | −2.3099E−01 | 6.4363E−02 | 1.8001E−02 |
| A8 | 2.4958E+00 | 3.0769E+00 | 1.9526E+00 | 6.8511E−01 | 1.4283E−01 | −2.3985E−02 | −3.4427E−03 |
| A10 | −3.9661E+00 | −3.8722E+00 | −2.0368E+00 | −5.3477E−01 | −6.4738E−02 | 8.3186E−03 | −1.0874E−04 |
| A12 | 4.3049E+00 | 3.2061E+00 | 1.3961E+00 | 2.9443E−01 | 2.1786E−02 | −1.9444E−03 | 2.1075E−04 |
| A14 | −3.1656E+00 | −1.7456E+00 | −6.2970E−01 | −1.0919E−01 | −5.2753E−03 | 2.7532E−04 | −4.4864E−05 |
| A16 | 1.5132E+00 | 5.9843E−01 | 1.8032E−01 | 2.5404E−02 | 8.5331E−04 | −2.2527E−05 | 4.4761E−06 |
| A18 | −4.2049E−01 | −1.1562E−01 | −2.9692E−02 | −3.2985E−03 | −8.0721E−05 | 9.6202E−07 | −2.2094E−07 |
| A20 | 5.0933E−02 | 9.3515E−03 | 2.1365E−03 | 1.8120E−04 | 3.3188E−06 | −1.5929E−08 | 4.3194E−09 |

FIG. 3b illustrates a longitudinal spherical aberration curve, an astigmatic field curve, and a distortion curve of the optical system of FIG. 3a. The longitudinal spherical aberration curve represents a focus deviation of each of light rays with different wavelengths after passing through each lens of the optical system. The astigmatic field curve represents a tangential field curvature and a sagittal field curvature. The distortion curve represents distortion values corresponding to different angles of view. As illustrated in FIG. 3b, the optical system of FIG. 3a can achieve good imaging quality.

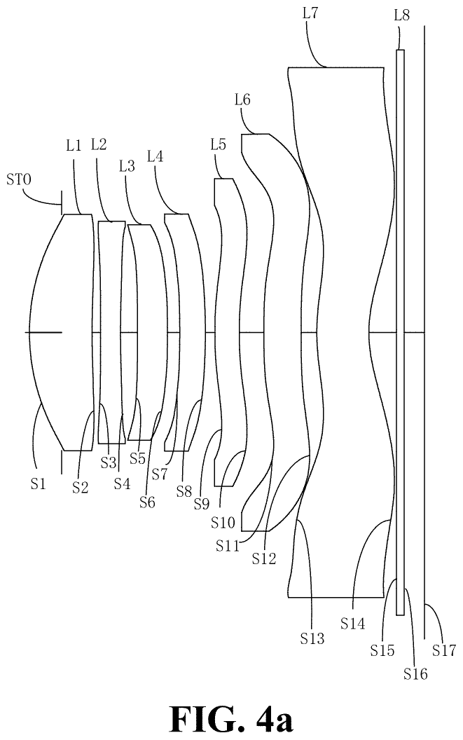

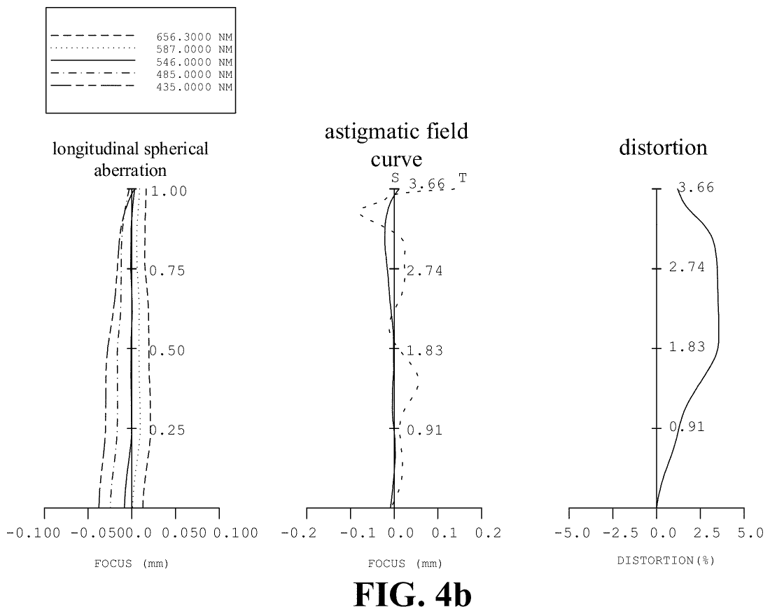

Referring to FIG. 4a and FIG. 4b, the optical system in this implementation includes, in order from the object side to the image side along the optical axis, the first lens L1, the second lens L2, the third lens L3, the fourth lens L4, the fifth lens L5, the sixth lens L6, and the seventh lens L7.

The first lens L1 has a positive refractive power. The object-side surface S1 of the first lens L1 is convex near the optical axis and a periphery of the object-side surface S1 of the first lens L1. The image-side surface S2 of the first lens L1 is concave near the the optical axis and is convex near a periphery of the image-side surface S2 of the first lens L1.

The second lens L2 has a negative refractive power. The object-side surface S3 of the second lens L2 is convex near the optical axis and is concave near a periphery of the object-side surface S3 of the second lens L2. The image-side surface S4 of the second lens L2 is concave near the optical axis and is convex near a periphery of the image-side surface S4 of the second lens L2.

The third lens L3 has a positive refractive power. The object-side surface S5 of the third lens L3 is convex near the optical axis and is concave near a periphery of the object-side surface S5 of the third lens L3. The image-side surface S6 of the third lens L3 is convex near the optical axis and a periphery of the image-side surface S6 of the third lens L3.

The fourth lens L4 has a positive refractive power. The object-side surface S7 of the fourth lens L4 is concave near the optical axis and a periphery of the object-side surface S7 of the fourth lens L4. The image-side surface S8 of the fourth lens L4 is convex near the optical axis and a periphery of the image-side surface S8 of the fourth lens L4.

The fifth lens L5 has a positive refractive power. The object-side surface S9 of the fifth lens L5 is convex near the optical axis and is concave near a periphery of the object-side surface S9 of the fifth lens L5. The image-side surface S10 of the fifth lens L5 is concave near the optical axis and is convex near a periphery of the image-side surface S10 of the fifth lens L5.

The sixth lens L6 has a positive refractive power. The object-side surface S11 of the sixth lens L6 is convex near the optical axis and is concave near a periphery of the object-side surface S11 of the sixth lens L6. The image-side surface S12 of the sixth lens L6 is concave near the optical axis and is convex near a periphery of image-side surface S12 of the sixth lens L6.

The seventh lens L7 has a negative refractive power. The object-side surface S13 of the seventh lens L7 is convex near the optical axis and is concave near a periphery of the object-side surface S13 of the seventh lens L7. The image-side surface S14 of the seventh lens L7 is concave near the optical axis and a periphery of image-side surface S14 of the seventh lens L7.

The other structures of the optical system of FIG. 4a are identical with the optical system of FIG. 1a, reference can be made to the optical system of FIG. 1a.

Table 4a illustrates characteristics of the optical system in this implementation. Data in Table 4a is obtained based on light with a wavelength of 546 nm. Each of Y radius, thickness, and focal length is in units of millimeter (mm).

TABLE 4a
Optical system of FIG. 4a
f = 3.98, FNO = 1.4, FOV = 82.00, TTL = 5.55

| Surface | Surface | | | Thick- | | Refractive | Abbe | Focal |
|---|---|---|---|---|---|---|---|---|
| Number | Name | Shape | Y Radius | ness | Material | Index | Number | length |
| Object | | Spherical | Infinity | Infinity | | | | |
| number | | | | | | | | |
| ST0 | Stop | Spherical | Infinity | −0.451 | | | | |
| S1 | First | Aspherical | 2.183 | 0.879 | Plastic | 1.544 | 55.912 | 4.99 |
| S2 | lens | Aspherical | 9.426 | 0.119 | | | | |
| S3 | Second | Aspherical | 55.602 | 0.280 | Plastic | 1.661 | 20.412 | −18.95 |
| S4 | lens | Aspherical | 10.295 | 0.238 | | | | |
| S5 | Third | Aspherical | 63.553 | 0.422 | Plastic | 1.544 | 55.912 | 17.65 |
| S6 | lens | Aspherical | −11.346 | 0.174 | | | | |
| S7 | Fourth | Aspherical | −8.782 | 0.358 | Plastic | 1.544 | 55.912 | 22.14 |
| S8 | lens | Aspherical | −5.161 | 0.136 | | | | |
| S9 | Fifth | Aspherical | 6.060 | 0.343 | Plastic | 1.661 | 20.412 | 753.79 |
| S10 | lens | Aspherical | 5.995 | 0.344 | | | | |
| S11 | Sixth | Aspherical | 21.725 | 0.525 | Plastic | 1.544 | 55.912 | 66.50 |
| S12 | lens | Aspherical | 53.567 | 0.218 | | | | |
| S13 | Seventh | Aspherical | 2.147 | 0.732 | Plastic | 1.544 | 55.912 | −9.93 |
| S14 | lens | Aspherical | 1.353 | 0.386 | | | | |
| S15 | Infrared | Spherical | Infinity | 0.110 | Glass | 1.517 | 64.167 | |
| S16 | cut−off | Spherical | Infinity | 0.285 | | | | |
| | filter | | | | | | | |
| S17 | Image | Spherical | Infinity | 0.000 | | | | |
| | plane | | | | | | | |

Note:
The reference wavelength is 546 nm

Each parameter in Table 4a represents the same meaning as that in the optical system of FIG. 1a.

Table 4b shows higher-order coefficients that can be used for each aspherical lens surface in the optical system of FIG. 4a, where a shape of each aspherical lens surface can be defined by the formula given in the optical system of FIG. 1a.

TABLE 4b
Optical system of FIG. 4a
Aspherical coefficients

| | Surface Number | | | | | | |
|---|---|---|---|---|---|---|---|
| | S1 | S2 | S3 | S4 | S5 | S6 | S7 |
| K | −1.4387E+00 | −2.5633E+00 | −3.8709E+01 | 6.5672E−01 | −9.9000E+01 | 2.3537E+01 | 3.9578E+01 |
| A4 | 1.4851E−02 | −4.7336E−02 | −7.3204E−02 | −7.2061E−02 | −1.7108E−01 | −1.1693E−01 | 9.5120E−02 |
| A6 | 8.2190E−03 | 7.4919E−02 | 4.4894E−02 | 1.2482E−01 | 5.9215E−01 | −4.8347E−02 | −1.0269E+00 |
| A8 | −4.1550E−02 | −1.8354E−01 | 7.5515E−02 | −2.3630E−01 | −1.6774E+00 | 8.3365E−01 | 3.5465E+00 |
| A10 | 9.4509E−02 | 3.6469E−01 | −1.5663E−01 | 5.4821E−01 | 3.1557E+00 | −1.9646E+00 | −6.6346E+00 |
| A12 | −1.1792E−01 | −4.7067E−01 | 8.9673E−02 | −9.2184E−01 | −3.8660E+00 | 2.4288E+00 | 7.6787E+00 |
| A14 | 8.5321E−02 | 3.6602E−01 | 1.0089E−02 | 9.2640E−01 | 2.9839E+00 | −1.8472E+00 | −5.6936E+00 |
| A16 | −3.5705E−02 | −1.6647E−01 | −3.0901E−02 | −5.3772E−01 | −1.3979E+00 | 8.6578E−01 | 2.6293E+00 |
| A18 | 7.9349E−03 | 4.0830E−02 | 1.2033E−02 | 1.6873E−01 | 3.6483E−01 | −2.2815E−01 | −6.8648E−01 |
| A20 | −7.2186E−04 | −4.1706E−03 | −1.5484E−03 | −2.2230E−02 | −4.0879E−02 | 2.5698E−02 | 7.7246E−02 |
| | Surface Number | | | | | | |
| | S8 | S9 | S10 | S11 | S12 | S13 | S14 |
| K | 6.8749E+00 | 0.0000E+00 | 0.0000E+00 | 0.0000E+00 | 0.0000E+00 | −4.7576E+00 | −3.9824E+00 |
| A4 | 2.6767E−01 | 2.5672E−01 | 2.3011E−01 | 2.3134E−01 | 1.0631E−01 | −1.5518E−01 | −7.5576E−02 |
| A6 | −1.0582E+00 | −7.1745E−01 | −5.4644E−01 | −3.1004E−01 | −6.9944E−02 | 8.4743E−02 | 3.0710E−02 |
| A8 | 2.1849E+00 | 9.3812E−01 | 6.1745E−01 | 2.6503E−01 | 2.2776E−02 | −4.9260E−02 | −8.0265E−03 |
| A10 | −2.7628E+00 | −7.3214E−01 | −4.4411E−01 | −1.7269E−01 | −7.1757E−03 | 1.9739E−02 | 8.3930E−04 |
| A12 | 2.2581E+00 | 3.3209E−01 | 2.1090E−01 | 8.0353E−02 | 2.6236E−03 | −4.7224E−03 | 7.6614E−05 |
| A14 | −1.2132E+00 | −7.3586E−02 | −6.6840E−02 | −2.5265E−02 | −8.1780E−04 | 6.7879E−04 | −3.0121E−05 |
| A16 | 4.1575E−01 | −9.8037E−04 | 1.3757E−02 | 4.9762E−03 | 1.6215E−04 | −5.7852E−05 | 3.2795E−06 |
| A18 | −8.2241E−02 | 3.9635E−03 | −1.6690E−03 | −5.4450E−04 | −1.7313E−05 | 2.6983E−06 | −1.6274E−07 |
| A20 | 7.1222E−03 | −5.8551E−04 | 9.0342E−05 | 2.5040E−05 | 7.5420E−07 | −5.3070E−08 | 3.1350E−09 |

FIG. 4b illustrates a longitudinal spherical aberration curve, an astigmatic field curve, and a distortion curve of the optical system of FIG. 4a. The longitudinal spherical aberration curve represents a focus deviation of each of light rays with different wavelengths after passing through each lens of the optical system. The astigmatic field curve represents a tangential field curvature and a sagittal field curvature. The distortion curve represents distortion values corresponding to different angles of view. As illustrated in FIG. 4b, the optical system of FIG. 4a can achieve good imaging quality.

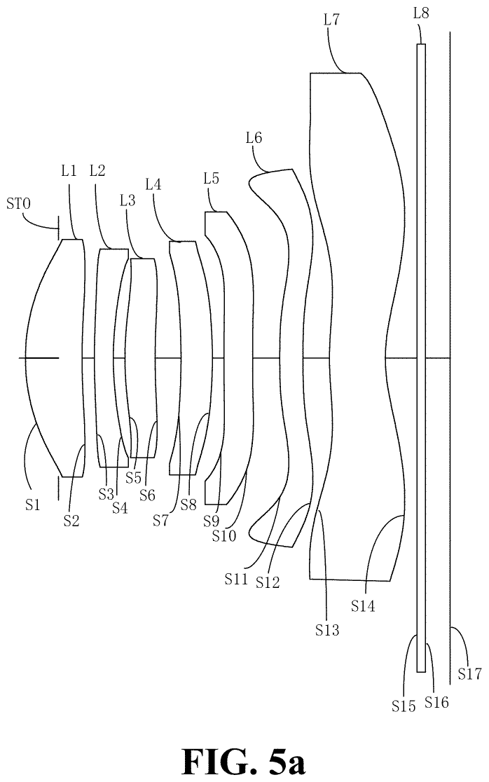

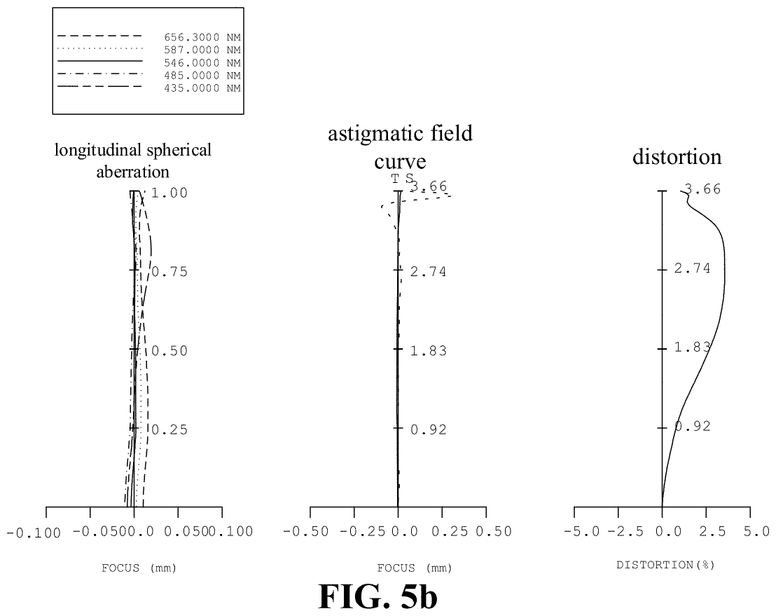

Referring to FIG. 5a and FIG. 5b, the optical system in this implementation includes, in order from the object side to the image side along the optical axis, the first lens L1, the second lens L2, the third lens L3, the fourth lens L4, the fifth lens L5, the sixth lens L6, and the seventh lens L7.

The first lens L1 has a positive refractive power. The object-side surface S1 of the first lens L1 is convex near the optical axis and a periphery of the object-side surface S1 of the first lens L1. The image-side surface S2 of the first lens L1 is concave near the the optical axis and is convex near a periphery of the image-side surface S2 of the first lens L1.

The second lens L2 has a negative refractive power. The object-side surface S3 of the second lens L2 is convex near the optical axis and a periphery of the object-side surface S3 of the second lens L2. The image-side surface S4 of the second lens L2 is concave near the optical axis and a periphery of the image-side surface S4 of the second lens L2.

The third lens L3 has a positive refractive power. The object-side surface S5 of the third lens L3 is convex near the optical axis and a periphery of the object-side surface S5 of the third lens L3. The image-side surface S6 of the third lens L3 is concave near the optical axis and is convex near a periphery of the image-side surface S6 of the third lens L3.

The fourth lens L4 has a positive refractive power. The object-side surface S7 of the fourth lens L4 is concave near the optical axis and a periphery of the object-side surface S7 of the fourth lens L4. The image-side surface S8 of the fourth lens L4 is convex near the optical axis and a periphery of the image-side surface S8 of the fourth lens L4.

The fifth lens L5 has a negative refractive power. The object-side surface S9 of the fifth lens L5 is concave near the optical axis and a periphery of the object-side surface S9 of the fifth lens L5. The image-side surface S10 of the fifth lens L5 is convex near the optical axis and a periphery of the image-side surface S10 of the fifth lens L5.

The sixth lens L6 has a positive refractive power. The object-side surface S11 of the sixth lens L6 is convex near the optical axis and is concave near a periphery of the object-side surface S11 of the sixth lens L6. The image-side surface S12 of the sixth lens L6 is concave near the optical axis and is convex near a periphery of image-side surface S12 of the sixth lens L6.

The seventh lens L7 has a negative refractive power. The object-side surface S13 of the seventh lens L7 is convex near the optical axis and a periphery of the object-side surface S13 of the seventh lens L7. The image-side surface S14 of the seventh lens L7 is concave near the optical axis and is convex near a periphery of image-side surface S14 of the seventh lens L7.

The other structures of the optical system in FIG. 5a are identical with the optical system of FIG. a, reference can be made to the optical system of FIG. 1a.

Table 5a illustrates characteristics of the optical system in this implementation. Data in Table 5a is obtained based on light with a wavelength of 546 nm. Each of Y radius, thickness, and focal length is in units of millimeter (mm).

TABLE 5a
Optical system of FIG. 5a
f = 4.52, FNO = 1.7, FOV = 74.98, TTL = 5.48

| Surface | Surface | | | Thick- | | Refractive | Abbe | Focal |
|---|---|---|---|---|---|---|---|---|
| Number | Name | Shape | Y Radius | ness | Material | Index | Number | length |
| Object | | Spherical | Infinity | Infinity | | | | |
| number | | | | | | | | |
| ST0 | Stop | Spherical | Infinity | −0.427 | | | | |
| S1 | First | Aspherical | 1.911 | 0.731 | Plastic | 1.544 | 55.912 | 4.66 |
| S2 | lens | Aspherical | 6.618 | 0.159 | | | | |
| S3 | Second | Aspherical | 6.697 | 0.244 | Plastic | 1.661 | 20.412 | −8.69 |
| S4 | lens | Aspherical | 3.064 | 0.151 | | | | |
| S5 | Third | Aspherical | 3.298 | 0.388 | Plastic | 1.544 | 55.912 | 11.19 |
| S6 | lens | Aspherical | 6.861 | 0.334 | | | | |
| S7 | Fourth | Aspherical | −7.424 | 0.406 | Plastic | 1.544 | 55.912 | 15.91 |
| S8 | lens | Aspherical | −4.082 | 0.149 | | | | |
| S9 | Fifth | Aspherical | −68.342 | 0.371 | Plastic | 1.661 | 20.412 | −356.29 |
| S10 | lens | Aspherical | −96.066 | 0.349 | | | | |
| S11 | Sixth | Aspherical | 16.705 | 0.300 | Plastic | 1.544 | 55.912 | 164.08 |
| S12 | lens | Aspherical | 20.400 | 0.342 | | | | |
| S13 | Seventh | Aspherical | 3.213 | 0.721 | Plastic | 1.544 | 55.912 | −6.21 |
| S14 | lens | Aspherical | 1.520 | 0.408 | | | | |
| S15 | Infrared | Spherical | Infinity | 0.110 | Glass | 1.517 | 64.167 | |
| S16 | cut−off | Spherical | Infinity | 0.319 | | | | |
| | filter | | | | | | | |
| S17 | Image | Spherical | Infinity | 0.000 | | | | |
| | plane | | | | | | | |

Note:
The reference wavelength is 546 nm

Each parameter in Table 5a represents the same meaning as that in the optical system of FIG. 1a.

Table 5b shows higher-order coefficients that can be used for each aspherical lens surface in the optical system of FIG. 5a, where a shape of each aspherical lens surface can be defined by the formula given in the optical system of FIG. 1a.

TABLE 5b
Optical system of FIG. 5a
Aspherical coefficients

| | Surface Number | | | | | | |
|---|---|---|---|---|---|---|---|
| | S1 | S2 | S3 | S4 | S5 | S6 | S7 |
| K | −1.4224E+00 | −2.0667E+00 | −7.6397E+00 | −2.4382E−01 | −1.7754E+00 | 5.8436E+00 | 4.4493E+00 |
| A4 | 2.1294E−02 | −4.0347E−02 | −8.4736E−02 | −8.6118E−02 | −6.0879E−02 | −3.0132E−02 | 1.8413E−02 |
| A6 | 8.3045E−03 | 1.6165E−02 | 9.2149E−02 | 1.2770E−01 | 3.7273E−02 | −5.4087E−02 | −1.9968E−01 |
| A8 | −3.0028E−02 | −1.9295E−02 | −9.8493E−02 | −1.9993E−01 | −1.1261E−01 | 1.6939E−01 | 6.4233E−01 |
| A10 | 6.6712E−02 | −5.5508E−03 | 1.0431E−01 | 3.9366E−01 | 1.7766E−01 | −4.9939E−01 | −1.4327E+00 |
| A12 | −9.6882E−02 | 4.1665E−02 | −7.2828E−02 | −6.8474E−01 | −2.5844E−01 | 8.5000E−01 | 2.1273E+00 |
| A14 | 8.5868E−02 | −5.2895E−02 | 2.7949E−02 | 8.5249E−01 | 2.6801E−01 | −9.2295E−01 | −2.0833E+00 |
| A16 | −4.5791E−02 | 3.2655E−02 | 1.0563E−04 | −6.7024E−01 | −1.9375E−01 | 6.1373E−01 | 1.2758E+00 |
| A18 | 1.3232E−02 | −1.0157E−02 | −3.6412E−03 | 2.9790E−01 | 9.3952E−02 | −2.1979E−01 | −4.3421E−01 |
| A20 | −1.6027E−03 | 1.2542E−03 | 7.3538E−04 | −5.6027E−02 | −2.0831E−02 | 3.1481E−02 | 6.1700E−02 |
| | Surface Number | | | | | | |
| | S8 | S9 | S10 | S11 | S12 | S13 | S14 |
| K | 3.5822E+00 | 0.0000E+00 | 0.0000E+00 | 0.0000E+00 | 0.0000E+00 | −2.6306E+00 | −5.6217E+00 |
| A4 | 2.1799E−01 | 2.8800E−01 | 2.4809E−01 | 3.4679E−01 | 2.0119E−01 | −2.1072E−01 | −8.7173E−02 |
| A6 | −8.9079E−01 | −1.1106E+00 | −7.8427E−01 | −5.8615E−01 | −2.1172E−01 | 1.2883E−01 | 4.6569E−02 |
| A8 | 2.1030E+00 | 2.1727E+00 | 1.1940E+00 | 5.7996E−01 | 1.0494E−01 | −6.7384E−02 | −1.9883E−02 |
| A10 | −3.3638E+00 | −2.8741E+00 | −1.2005E+00 | −4.2325E−01 | −3.2207E−02 | 2.6671E−02 | 6.0325E−03 |
| A12 | 3.6795E+00 | 2.5783E+00 | 8.1695E−01 | 2.1929E−01 | 6.4899E−03 | −6.9511E−03 | −1.2723E−03 |
| A14 | −2.7039E+00 | −1.5450E+00 | −3.7336E−01 | −7.6529E−02 | −1.0038E−03 | 1.1491E−03 | 1.8000E−04 |
| A16 | 1.2703E+00 | 5.8554E−01 | 1.0946E−01 | 1.6742E−02 | 1.4723E−04 | −1.1656E−04 | −1.6035E−05 |
| A18 | −3.4143E−01 | −1.2496E−01 | −1.8484E−02 | −2.0490E−03 | −1.6996E−05 | 6.6439E−06 | 8.0467E−07 |
| A20 | 3.9595E−02 | 1.1233E−02 | 1.3582E−03 | 1.0673E−04 | 9.0807E−07 | −1.6347E−07 | −1.7256E−08 |

FIG. 5b illustrates a longitudinal spherical aberration curve, an astigmatic field curve, and a distortion curve of the optical system of FIG. 5a. The longitudinal spherical aberration curve represents a focus deviation of each of light rays with different wavelengths after passing through each lens of the optical system. The astigmatic field curve represents a tangential field curvature and a sagittal field curvature. The distortion curve represents distortion values corresponding to different angles of view. As illustrated in FIG. 5b, the optical system of FIG. 5a can achieve good imaging quality.

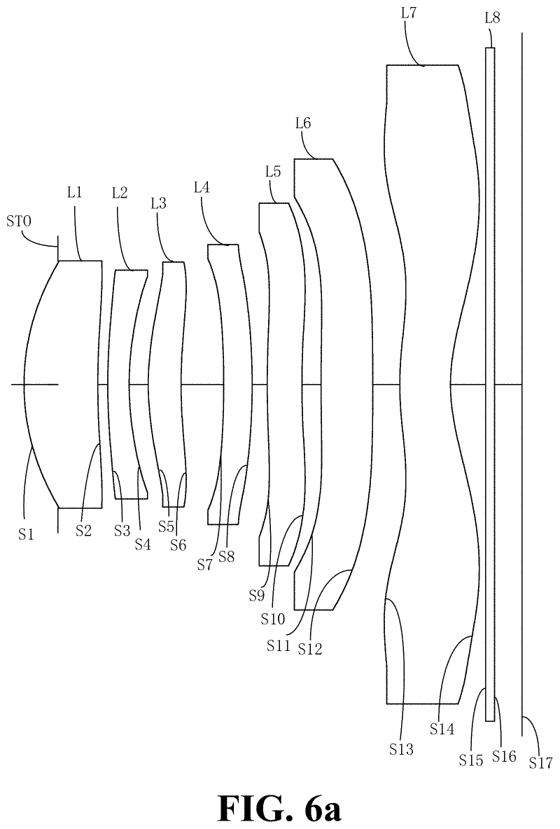

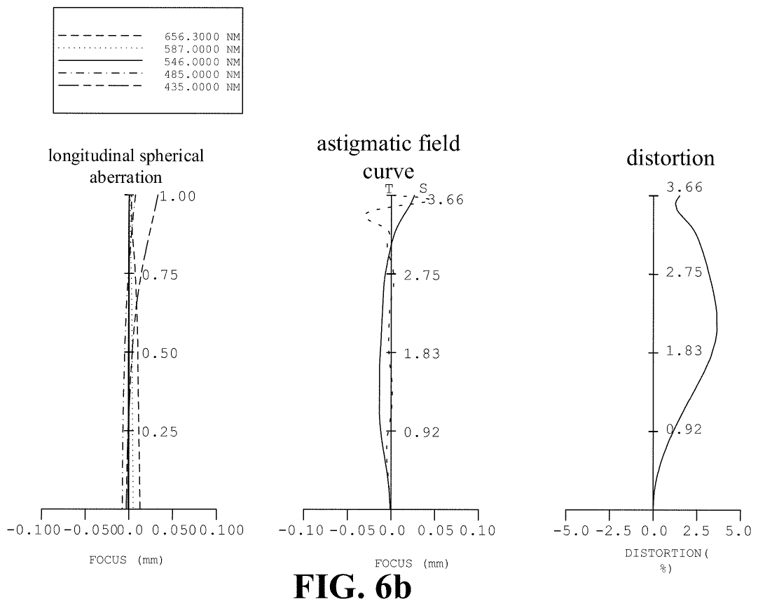

Referring to FIG. 6a and FIG. 6b, the optical system in this implementation includes, in order from the object side to the image side along the optical axis, the first lens L1, the second lens L2, the third lens L3, the fourth lens L4, the fifth lens L5, the sixth lens L6, and the seventh lens L7.

The first lens L1 has a positive refractive power. The object-side surface S1 of the first lens L1 is convex near the optical axis and a periphery of the object-side surface S1 of the first lens L1. The image-side surface S2 of the first lens L1 is concave near the the optical axis and is convex near a periphery of the image-side surface S2 of the first lens L1.

The second lens L2 has a negative refractive power. The object-side surface S3 of the second lens L2 is convex near the optical axis and a periphery of the object-side surface S3 of the second lens L2. The image-side surface S4 of the second lens L2 is concave near the optical axis and a periphery of the image-side surface S4 of the second lens L2.

The third lens L3 has a positive refractive power. The object-side surface S5 of the third lens L3 is convex near the optical axis and a periphery of the object-side surface S5 of the third lens L3. The image-side surface S6 of the third lens L3 is concave near the optical axis and is convex near a periphery of the image-side surface S6 of the third lens L3.

The fourth lens L4 has a positive refractive power. The object-side surface S7 of the fourth lens L4 is concave near the optical axis and a periphery of the object-side surface S7 of the fourth lens L4. The image-side surface S8 of the fourth lens L4 is convex near the optical axis and a periphery of the image-side surface S8 of the fourth lens L4.

The fifth lens L5 has a negative refractive power. The object-side surface S9 of the fifth lens L5 is convex near the optical axis and is concave near a periphery of the object-side surface S9 of the fifth lens L5. The image-side surface S10 of the fifth lens L5 is concave near the optical axis and is convex near a periphery of the image-side surface S10 of the fifth lens L5.

The sixth lens L6 has a positive refractive power. The object-side surface S11 of the sixth lens L6 is convex near the optical axis and is concave near a periphery of the object-side surface S11 of the sixth lens L6. The image-side surface S12 of the sixth lens L6 is convex near the optical axis and a periphery of image-side surface S12 of the sixth lens L6.

The seventh lens L7 has a negative refractive power. The object-side surface S13 of the seventh lens L7 is convex near the optical axis and a periphery of the object-side surface S13 of the seventh lens L7. The image-side surface S14 of the seventh lens L7 is concave near the optical axis and is convex near a periphery of image-side surface S14 of the seventh lens L7.

The other structures of the optical system of FIG. 6a are identical with the optical system of FIG. 1a, reference can be made to the optical system of FIG. 1a.

Table 6a illustrates characteristics of the optical system in this implementation. Data in Table 6a is obtained based on light with a wavelength of 546 nm. Each of Y radius, thickness, and focal length is in units of millimeter (mm).

TABLE 6a
Optical system of FIG. 6a
f = 4.90, FNO = 1.9, FOV = 70.73, TTL = 6.00

| Surface | Surface | | | Thick- | | Refractive | Abbe | Focal |
|---|---|---|---|---|---|---|---|---|
| Number | Name | Shape | Y Radius | ness | Material | Index | Number | length |
| Object | | Spherical | Infinity | Infinity | | | | |
| number | | | | | | | | |
| ST0 | Stop | Spherical | Infinity | −0.409 | | | | |
| S1 | First | Aspherical | 2.090 | 0.889 | Plastic | 1.544 | 55.912 | 5.40 |
| S2 | lens | Aspherical | 6.939 | 0.119 | | | | |
| S3 | Second | Aspherical | 4.993 | 0.258 | Plastic | 1.661 | 20.412 | −8.59 |
| S4 | lens | Aspherical | 2.614 | 0.231 | | | | |
| S5 | Third | Aspherical | 2.632 | 0.396 | Plastic | 1.544 | 55.912 | 9.57 |
| S6 | lens | Aspherical | 5.014 | 0.513 | | | | |
| S7 | Fourth | Aspherical | −7.708 | 0.343 | Plastic | 1.544 | 55.912 | 38.02 |
| S8 | lens | Aspherical | −5.710 | 0.181 | | | | |
| S9 | Fifth | Aspherical | 10.793 | 0.419 | Plastic | 1.661 | 20.412 | −176.366 |
| S10 | lens | Aspherical | 9.734 | 0.230 | | | | |
| S11 | Sixth | Aspherical | 599.123 | 0.622 | Plastic | 1.544 | 55.912 | 52.63 |
| S12 | lens | Aspherical | −30.200 | 0.325 | | | | |
| S13 | Seventh | Aspherical | 2.785 | 0.611 | Plastic | 1.544 | 55.912 | −9.35 |
| S14 | lens | Aspherical | 1.663 | 0.421 | | | | |
| S15 | Infrared | Spherical | Infinity | 0.110 | Glass | 1.517 | 64.167 | |
| S16 | cut−off | Spherical | Infinity | 0.332 | | | | |
| | filter | | | | | | | |
| S17 | Image | Spherical | Infinity | 0.000 | | | | |
| | plane | | | | | | | |

Note:
The reference wavelength is 546 nm

Each parameter in Table 6a represents the same meaning as that in the optical system of FIG. 1a.

Table 6b shows higher-order coefficients that can be used for each aspherical lens surface in the optical system of FIG. 6a, where a shape of each aspherical lens surface can be defined by the formula given in the optical system of FIG. 1a.

TABLE 6b
Optical system of FIG. 6a
Aspherical coefficients

| | Surface Number | | | | | | |
|---|---|---|---|---|---|---|---|
| | S1 | S2 | S3 | S4 | S5 | S6 | S7 |
| K | −1.3523E+00 | −3.0427E+00 | −5.3630E+00 | −3.4514E−01 | −1.3619E−01 | −2.1329E+00 | 1.0994E+01 |
| A4 | 1.5896E−02 | −4.1252E−02 | −8.3873E−02 | −8.7519E−02 | −5.9052E−02 | −1.8372E−02 | 1.8604E−02 |
| A6 | −4.9604E−04 | 7.0700E−02 | 1.6143E−01 | 1.4825E−01 | 2.8357E−02 | −3.0923E−02 | −9.7805E−02 |
| A8 | 2.7941E−03 | −1.4423E−01 | −2.5500E−01 | −1.7863E−01 | −1.3232E−02 | 7.1187E−02 | 2.9150E−01 |
| A10 | −5.5397E−03 | 2.0165E−01 | 3.1513E−01 | 1.7455E−01 | −4.7893E−02 | −1.7860E−01 | −5.9663E−01 |
| A12 | 5.5188E−03 | −2.0328E−01 | −3.0130E−01 | −1.5230E−01 | 1.0560E−01 | 2.6415E−01 | 7.3770E−01 |
| A14 | −3.8712E−03 | 1.3641E−01 | 2.0471E−01 | 1.1895E−01 | −1.1470E−01 | −2.4931E−01 | −5.6845E−01 |
| A16 | 1.7306E−03 | −5.6191E−02 | −8.8188E−02 | −6.8287E−02 | 7.0809E−02 | 1.4371E−01 | 2.6314E−01 |
| A18 | −4.6898E−04 | 1.2771E−02 | 2.1356E−02 | 2.3651E−02 | −2.2732E−02 | −4.4925E−02 | −6.5232E−02 |
| A20 | 5.6291E−05 | −1.2254E−03 | −2.2190E−03 | −3.5578E−03 | 2.9136E−03 | 5.7624E−03 | 6.4319E−03 |
| | Surface Number | | | | | | |
| | S8 | S9 | S10 | S11 | S12 | S13 | S14 |
| K | 2.4936E+00 | 3.5677E+01 | 0.0000E+00 | 9.9000E+01 | 9.9000E+01 | −3.0530E+00 | −4.0393E+00 |
| A4 | 2.5375E−02 | 1.8896E−02 | 5.9759E−02 | 7.0247E−02 | −2.1228E−03 | −1.2979E−01 | −5.7590E−02 |
| A6 | −3.8906E−02 | −1.0170E−01 | −1.7297E−01 | −1.4442E−01 | −1.7657E−02 | 4.7754E−02 | 1.9822E−02 |
| A8 | 5.6496E−02 | 1.0574E−01 | 1.6900E−01 | 1.1182E−01 | 1.0012E−02 | −1.6734E−02 | −5.4332E−03 |
| A10 | −9.5223E−02 | −7.9442E−02 | −1.0313E−01 | −5.4506E−02 | −2.0269E−03 | 5.2278E−03 | 1.0710E−03 |
| A12 | 1.1945E−01 | 4.7203E−02 | 4.2287E−02 | 1.8781E−02 | −2.8340E−04 | −1.0987E−03 | −1.5569E−04 |
| A14 | −9.8676E−02 | −2.3284E−02 | −1.1986E−02 | −4.8976E−03 | 2.3524E−04 | 1.4358E−04 | 1.6760E−05 |
| A16 | 4.9616E−02 | 8.3601E−03 | 2.3161E−03 | 9.2533E−04 | −5.1623E−05 | −1.1268E−05 | −1.2229E−06 |
| A18 | −1.3337E−02 | −1.7619E−03 | −2.7726E−04 | −1.0716E−04 | 5.3256E−06 | 4.8764E−07 | 5.1701E−08 |
| A20 | 1.4508E−03 | 1.5705E−04 | 1.5332E−05 | 5.4511E−06 | −2.2089E−07 | −8.9608E−09 | −9.3464E−10 |

FIG. 6b illustrates a longitudinal spherical aberration curve, an astigmatic field curve, and a distortion curve of the optical system of FIG. 6a. The longitudinal spherical aberration curve represents a focus deviation of each of light rays with different wavelengths after passing through each lens of the optical system. The astigmatic field curve represents a tangential field curvature and a sagittal field curvature. The distortion curve represents distortion values corresponding to different angles of view. As illustrated in FIG. 6b, the optical system of FIG. 6a can achieve good imaging quality.

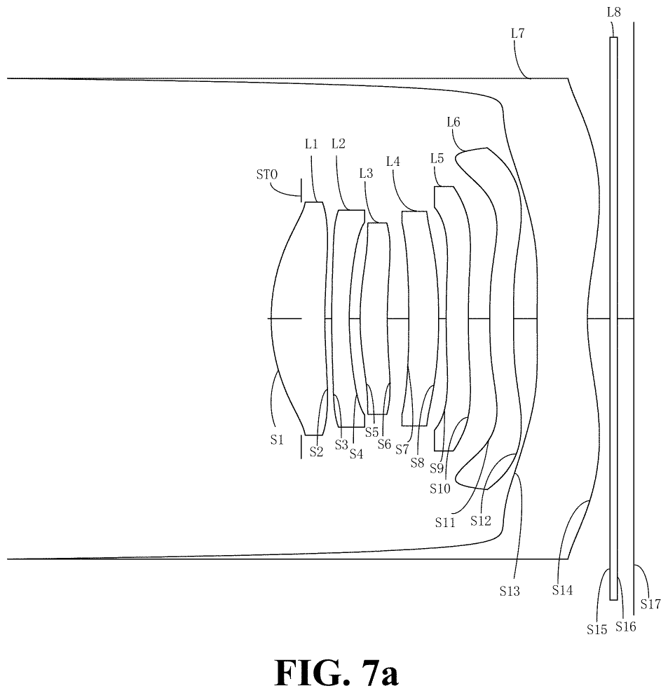

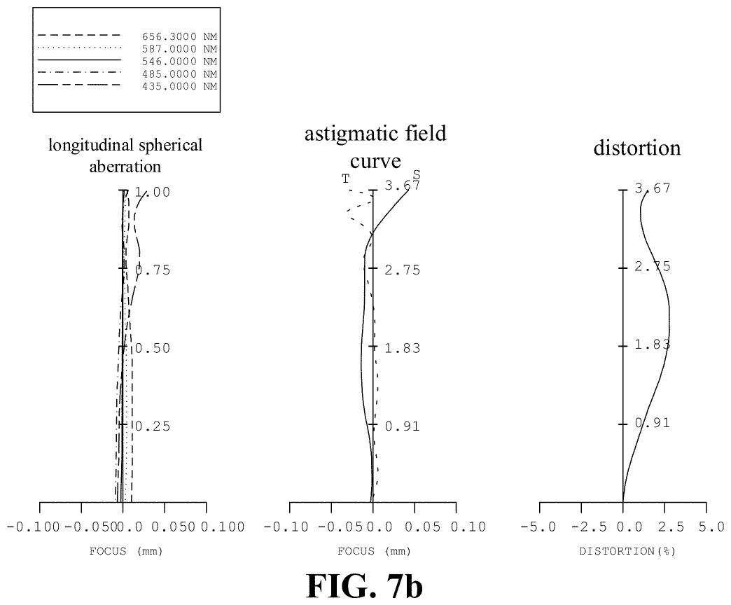

Referring to FIG. 7a and FIG. 7b, the optical system in this implementation includes, in order from the object side to the image side along the optical axis, the first lens L1, the second lens L2, the third lens L3, the fourth lens L4, the fifth lens L5, the sixth lens L6, and the seventh lens L7.

The first lens L1 has a positive refractive power. The object-side surface S1 of the first lens L1 is convex near the optical axis and a periphery of the object-side surface S1 of the first lens L1. The image-side surface S2 of the first lens L1 is concave near the the optical axis and is convex near a periphery of the image-side surface S2 of the first lens L1.

The second lens L2 has a negative refractive power. The object-side surface S3 of the second lens L2 is convex near the optical axis and a periphery of the object-side surface S3 of the second lens L2. The image-side surface S4 of the second lens L2 is concave near the optical axis and a periphery of the image-side surface S4 of the second lens L2.

The third lens L3 has a positive refractive power. The object-side surface S5 of the third lens L3 is convex near the optical axis and a periphery of the object-side surface S5 of the third lens L3. The image-side surface S6 of the third lens L3 is concave near the optical axis and is convex near a periphery of the image-side surface S6 of the third lens L3.

The fourth lens L4 has a positive refractive power. The object-side surface S7 of the fourth lens L4 is concave near the optical axis and a periphery of the object-side surface S7 of the fourth lens L4. The image-side surface S8 of the fourth lens L4 is convex near the optical axis and a periphery of the image-side surface S8 of the fourth lens L4.

The fifth lens L5 has a positive refractive power. The object-side surface S9 of the fifth lens L5 is convex near the optical axis and is concave near a periphery of the object-side surface S9 of the fifth lens L5. The image-side surface S10 of the fifth lens L5 is concave near the optical axis and is convex near a periphery of the image-side surface S10 of the fifth lens L5.

The sixth lens L6 has a positive refractive power. The object-side surface S11 of the sixth lens L6 is convex near the optical axis and is concave near a periphery of the object-side surface S11 of the sixth lens L6. The image-side surface S12 of the sixth lens L6 is concave near the optical axis and is convex near a periphery of image-side surface S12 of the sixth lens L6.

The seventh lens L7 has a negative refractive power. The object-side surface S13 of the seventh lens L7 is convex near the optical axis and is concave near a periphery of the object-side surface S13 of the seventh lens L. The image-side surface S14 of the seventh lens L7 is concave near the optical axis and is convex near a periphery of image-side surface S14 of the seventh lens L7.

The other structures of the optical system of FIG. 7a are identical with the optical system of FIG. 1a, reference can be made to the optical system of FIG. 1a.

Table 7a illustrates characteristics of the optical system in this implementation. Data in Table 7a is obtained based on light with a wavelength of 546 nm. Each of Y radius, thickness, and focal length is in units of millimeter (mm).

TABLE 7a
Optical system of FIG. 7a
f = 4.33, FNO = 1.5, FOV = 77.62, TTL = 5.36

| Surface | Surface | | | Thick- | | Refractive | Abbe | Focal |
|---|---|---|---|---|---|---|---|---|
| Number | Name | Shape | Y Radius | ness | Material | Index | Number | length |
| Object | | Spherical | Infinity | Infinity | | | | |
| number | | | | | | | | |
| ST0 | Stop | Spherical | Infinity | −0.442 | | | | |
| S1 | First | Aspherical | 1.917 | 0.793 | Plastic | 1.544 | 55.912 | 4.80 |
| S2 | lens | Aspherical | 6.076 | 0.100 | | | | |
| S3 | Second | Aspherical | 8.056 | 0.260 | Plastic | 1.661 | 20.412 | −8.15 |
| S4 | lens | Aspherical | 3.208 | 0.159 | | | | |
| S5 | Third | Aspherical | 2.615 | 0.402 | Plastic | 1.544 | 55.912 | 8.70 |
| S6 | lens | Aspherical | 5.496 | 0.318 | | | | |
| S7 | Fourth | Aspherical | −12.787 | 0.441 | Plastic | 1.544 | 55.912 | 14.28 |
| S8 | lens | Aspherical | −4.906 | 0.111 | | | | |
| S9 | Fifth | Aspherical | 24.436 | 0.328 | Plastic | 1.661 | 20.412 | 138.93 |
| S10 | lens | Aspherical | 32.987 | 0.316 | | | | |
| S11 | Sixth | Aspherical | 12.559 | 0.350 | Plastic | 1.544 | 55.912 | 42.14 |
| S12 | lens | Aspherical | 27.366 | 0.349 | | | | |
| S13 | Seventh | Aspherical | 15.129 | 0.741 | Plastic | 1.544 | 55.912 | −4.72 |
| S14 | lens | Aspherical | 2.168 | 0.333 | | | | |
| S15 | Infrared | Spherical | Infinity | 0.110 | Glass | 1.517 | 64.167 | |
| S16 | cut−off | Spherical | Infinity | 0.244 | | | | |
| | filter | | | | | | | |
| S17 | Image | Spherical | Infinity | 0.000 | | | | |
| | plane | | | | | | | |

Note:
The reference wavelength is 546 nm

Each parameter in Table 7a represents the same meaning as that in the optical system of FIG. 1a.

Table 7b shows higher-order coefficients that can be used for each aspherical lens surface in the optical system of FIG. 7a, where a shape of each aspherical lens surface can be defined by the formula given in the optical system of FIG. 1a.

TABLE 7b
Optical system of FIG. 7a
Aspherical coefficients

| | Surface Number | | | | | | |
|---|---|---|---|---|---|---|---|
| | S1 | S2 | S3 | S4 | S5 | S6 | S7 |
| K | −1.5275E+00 | −6.1075E+00 | −3.0017E+00 | −5.2646E−01 | −2.1565E+00 | 1.6676E+00 | −2.7536E+01 |
| A4 | 2.0737E−02 | −6.6257E−02 | −1.1683E−01 | −1.2792E−01 | −9.4561E−02 | −4.0851E−02 | −3.3033E−02 |
| A6 | 1.5799E−02 | 1.0085E−01 | 2.1760E−01 | 2.6488E−01 | 1.3870E−01 | 4.2125E−02 | 5.1417E−02 |
| A8 | −6.9819E−02 | −1.7366E−01 | −2.3475E−01 | −4.1383E−01 | −3.8857E−01 | −1.7805E−01 | −1.2313E−01 |
| A10 | 1.6035E−01 | 1.7846E−01 | 6.8118E−02 | 6.4671E−01 | 7.9105E−01 | 2.6423E−01 | 2.4745E−01 |
| A12 | −2.2095E−01 | −1.2639E−01 | 1.6627E−01 | −9.8081E−01 | −1.2000E+00 | −2.4446E−01 | −3.7517E−01 |
| A14 | 1.8130E−01 | 6.3060E−02 | −2.4065E−01 | 1.1479E+00 | 1.2060E+00 | 9.6423E−02 | 3.5546E−01 |
| A16 | −8.7626E−02 | −2.0860E−02 | 1.5043E−01 | −8.5584E−01 | −7.5957E−01 | 2.1489E−02 | −2.0577E−01 |
| A18 | 2.2754E−02 | 3.9675E−03 | −4.7146E−02 | 3.5471E−01 | 2.7775E−01 | −2.6301E−02 | 7.1527E−02 |
| A20 | −2.4400E−03 | −3.2069E−04 | 5.9636E−03 | −6.1562E−02 | −4.4959E−02 | 4.7541E−03 | −1.1983E−02 |
| | Surface Number | | | | | | |
| | S8 | S9 | S10 | S11 | S12 | S13 | S14 |
| K | 3.6241E+00 | −9.9000E+01 | −6.3799E+01 | −9.9000E+01 | −9.9000E+01 | 2.2076E+01 | −6.1012E+00 |
| A4 | 1.1823E−01 | 2.5425E−01 | 2.5731E−01 | 2.6965E−01 | 1.9009E−01 | −1.0718E−01 | −7.3338E−02 |
| A6 | −5.4786E−01 | −9.4811E−01 | −6.9712E−01 | −4.1459E−01 | −1.8585E−01 | 4.5058E−02 | 3.3280E−02 |
| A8 | 1.2051E+00 | 1.7293E+00 | 9.7208E−01 | 3.7872E−01 | 8.4113E−02 | −2.7666E−02 | −1.2958E−02 |
| A10 | −1.6767E+00 | −2.1076E+00 | −9.1876E−01 | −2.7856E−01 | −2.3155E−02 | 1.9450E−02 | 3.4557E−03 |
| A12 | 1.5947E+00 | 1.7384E+00 | 5.9729E−01 | 1.5211E−01 | 3.2870E−03 | −8.4401E−03 | −5.9671E−04 |
| A14 | −1.0423E+00 | −9.5439E−01 | −2.6315E−01 | −5.7517E−02 | 3.9072E−05 | 2.1005E−03 | 6.4861E−05 |
| A16 | 4.4787E−01 | 3.2835E−01 | 7.4470E−02 | 1.3836E−02 | −9.9064E−05 | −2.9819E−04 | −4.2365E−06 |
| A18 | −1.3337E−02 | −1.7619E−03 | −2.7726E−04 | −1.0716E−04 | 5.3256E−06 | 4.8764E−07 | 5.1701E−08 |
| A20 | 1.4508E−03 | 1.5705E−04 | 1.5332E−05 | 5.4511E−06 | −2.2089E−07 | −8.9608E−09 | −9.3464E−10 |

FIG. 7b illustrates a longitudinal spherical aberration curve, an astigmatic field curve, and a distortion curve of the optical system of FIG. 7a. The longitudinal spherical aberration curve represents a focus deviation of each of light rays with different wavelengths after passing through each lens of the optical system. The astigmatic field curve represents a tangential field curvature and a sagittal field curvature. The distortion curve represents distortion values corresponding to different angles of view. As illustrated in FIG. 7b, the optical system of FIG. 7a can achieve good imaging quality.

Table 8 shows values of f/EPD, TTL/ImgH, SD11/SD31, |f/f4|, |f6/R61|, CT4+T45/CT5+CT6, |R71−R72|/|R71+R72|, and R22/R31 of the optical systems of FIG. 1a, FIG. 2a, FIG. 3a, FIG. 4a, FIG. 5a, FIG. 6a, and FIG. 7a.

TABLE 8

| | 1.4 ≤ ƒ/ | 1.3 < TTL/ | 0.9 < SD11/ | \|ƒ/ƒ4\| ≤ |
|---|---|---|---|---|
| | EPD ≤ 2.0 | ImgH < 1.7 | SD31 <1.3 | 0.30 |
| Optical system | 1.6 | 1.42 | 1.21 | 0.27 |
| of FIG. 1a | | | | |
| Optical system | 2.0 | 1.37 | 0.97 | 0.10 |
| of FIG. 2a | | | | |
| Optical system | 1.8 | 1.37 | 1.03 | 0.26 |
| of FIG. 3a | | | | |
| Optical system | 1.4 | 1.52 | 1.12 | 0.18 |
| of FIG. 4a | | | | |
| Optical system | 1.7 | 1.50 | 1.19 | 0.28 |
| of FIG. 5a | | | | |
| Optical system | 1.9 | 1.64 | 1.12 | 0.13 |
| of FIG. 6a | | | | |
| Optical system | 1.5 | 1.46 | 1.22 | 0.30 |
| of FIG. 7a | | | | |
| | | 0.50 ≤ CT4 + | 0.22 ≤ \|R71 − | |
| | \|ƒ6/R61\| < | T45/CT5 + | R72\|/\|R71 + | R22/R31 < |
| | 10.0 | CT6 ≤ 0.81 | R72\| < 0.8 | 1.3 |
| Optical system | 1.00E+17 | 0.68 | 0.27 | 1.12 |
| of FIG. 1a | | | | |
| Optical system | 3.66 | 0.77 | 0.22 | 1.09 |
| of FIG. 2a | | | | |
| Optical system | 2.36 | 0.56 | 0.25 | 0.91 |
| of FIG. 3a | | | | |
| Optical system | 3.06 | 0.58 | 0.23 | 0.87 |
| of FIG. 4a | | | | |
| Optical system | 9.92 | 0.83 | 0.36 | 0.16 |
| of FIG. 5a | | | | |
| Optical system | 0.09 | 0.50 | 0.25 | 0.99 |
| of FIG. 6a | | | | |
| Optical system | 3.35 | 0.81 | 0.75 | 1.23 |
| of FIG. 7a | | | | |

As illustrated in Table 8, each of the implementations of the present disclosure satisfies the following expressions. 1.4≤f/EPD≤2.0. 1.3<TTL/ImgH<1.7. 0.9<SD11/SD31<1.3. |f/f4|≤0.30. |f6/R61|<10.0. 0.50≤CT4+T45/CT5+CT6≤0.81. 0.22≤|R71−R72|/|R71+R72|<0.8. R22/R31<1.3. A region of the image-side surface of the sixth lens in the optical system of FIG. 1a near the optical axis is a plane, which has a radius of curvature of infinite. 1.00E+17 is calculated by taking the direct reading value of the design software, and its meaning is infinite.

Preferred implementations of the present disclosure have been described above, which cannot be understood as limitations on the present disclosure. Those skilled in the art can appreciate all or part of processes of carrying out the above-mentioned implementations, make equivalent changes based on the claims of the present disclosure, and these equivalent changes are also considered to fall into the protection scope of the present disclosure.

What is claimed is:

1. An optical system comprising, in order from an object side to an image side along an optical axis:
a first lens with a positive refractive power, wherein the first lens has an object-side surface which is convex, and an image-side surface which is concave near the optical axis;
a second lens with a negative refractive power, wherein the second lens has an object-side surface which is convex near the optical axis, and an image-side surface which is concave;
a third lens with a positive refractive power, wherein the third lens has an object-side surface which is convex;
a fourth lens with a refractive power, wherein the fourth lens has an object-side surface which is convex near the optical axis, and an image-side surface which is convex near the optical axis;
a fifth lens with a refractive power, wherein the fifth lens has an object-side surface which is concave near a periphery of the object-side surface of the fifth lens, and an image-side surface which is convex near a periphery of the image-side surface of the fifth lens, and wherein both the object-side surface and the image-side surface of the fifth lens are aspherical;
a sixth lens with a refractive power, wherein the sixth lens has an object-side surface which is concave near a periphery of the object-side surface of the sixth lens, and an image-side surface which is convex near a periphery of the image-side surface of the the sixth lens, and wherein both the object-side surface and the image-side surface of the sixth lens are aspherical, at least one of the object-side surface and the image-side surface of the sixth lens has at least one inflection point; and
a seventh lens with a negative refractive power, wherein the seventh lens has an object-side surface which is convex near the optical axis, and an image-side surface which is concave near the optical axis, and wherein both the object-side surface and the image-side surface of the seventh lens are aspherical, at least one of the object-side surface and the image-side surface of the seventh lens has at least one inflection point.

2. The optical system of claim 1, wherein the optical system satisfies the following expression:
1.4≤f/EPD≤2.0;
wherein f represents an effective focal length of the optical system, EPD represents an entrance pupil diameter of the optical system.

3. The optical system of claim 1, wherein the optical system satisfies the following expression:
1.3<TTL/ImgH<1.7;
wherein TTL represents a distance from the object-side surface of the first lens to an image plane on the optical axis, ImgH represents half of a diagonal length of an effective pixel region on the image plane.

4. The optical system of claim 1, wherein the optical system satisfies the following expression:
0.9<SD11/SD31<1.3;
wherein SD11 represents half of a clear aperture of the object-side surface of the first lens, SD31 represents half of a clear aperture of the object-side surface of the third lens.

5. The optical system of claim 1, wherein the optical system satisfies the following expression:

|f/f4|≤0.30;
wherein f represents an effective focal length of the optical system, f4 represents an effective focal length of the fourth lens.

6. The optical system of claim 1, wherein the optical system satisfies the following expression:

|f6/R61|<10.0;
wherein f6 represents an effective focal length of the sixth lens, R61 represents a radius of curvature of the object-side surface of the sixth lens near the optical axis.

7. The optical system of claim 1, wherein the optical system satisfies the following expression:
0.50≤CT4+T45/CT5+CT6≤0.81;
wherein CT4 represents a thickness of the fourth lens on the optical axis, T45 represents a distance from the fourth lens to the fifth lens on the optical axis, CT5 represents a thickness of the fifth lens on the optical axis, and CT6 represents a thickness of the sixth lens on the optical axis.

8. The optical system of claim 1, wherein the optical system satisfies the following expression:
0.22≤|R71−R72|R71+R72|<0.8;
wherein R71 represents a radius of curvature of the object-side surface of the seventh lens near the optical axis, R72 represents a radius of curvature of the image-side surface of the seventh lens near the optical axis.

9. The optical system of claim 1, wherein the optical system satisfies the following expression:
R22/R31<1.3;
wherein R22 represents a radius of curvature of the image-side surface of the second lens near the optical axis, R31 represents a radius of curvature of the object-side surface of the third lens near the optical axis.

10. A lens module, comprising:
a lens barrel; and
an optical system comprising, in order from an object side to an image side along an optical axis:
a first lens with a positive refractive power, wherein the first lens has an object-side surface which is convex, and an image-side surface which is concave near the optical axis;
a second lens with a negative refractive power, wherein the second lens has an object-side surface which is convex near the optical axis, and an image-side surface which is concave;
a third lens with a positive refractive power, wherein the third lens has an object-side surface which is convex;
a fourth lens with a refractive power, wherein the fourth lens has an object-side surface which is convex near the optical axis, and an image-side surface which is convex near the optical axis;
a fifth lens with a refractive power, wherein the fifth lens has an object-side surface which is concave near a periphery of the object-side surface of the fifth lens, and an image-side surface which is convex near a periphery of the image-side surface of the fifth lens, and wherein both the object-side surface and the image-side surface of the fifth lens are aspherical;
a sixth lens with a refractive power, wherein the sixth lens has an object-side surface which is concave near a periphery of the object-side surface of the sixth lens, and an image-side surface which is convex near a periphery of the image-side surface of the the sixth lens, and wherein both the object-side surface and the image-side surface of the sixth lens are aspherical, at least one of the object-side surface and the image-side surface of the sixth lens has at least one inflection point; and
a seventh lens with a negative refractive power, wherein the seventh lens has an object-side surface which is convex near the optical axis, and an image-side surface which is concave near the optical axis, and wherein both the object-side surface and the image-side surface of the seventh lens are aspherical, at least one of the object-side surface and the image-side surface of the seventh lens has at least one inflection point;
wherein the first to seventh lenses of the optical system are received in the lens barrel.

11. The lens module of claim 10, wherein the optical system satisfies the following expression:
1.4≤f/EPD≤2.0;
wherein f represents an effective focal length of the optical system, EPD represents an entrance pupil diameter of the optical system.

12. The lens module of claim 10, wherein the optical system satisfies the following expression:
1.3<TTL/ImgH<1.7;
wherein TTL represents a distance from the object-side surface of the first lens to an image plane on the optical axis, ImgH represents half of a diagonal length of an effective pixel region on the image plane.

13. The lens module of claim 10, wherein the optical system satisfies the following expression:
0.9<SD11/SD31<1.3;
wherein SD11 represents half of a clear aperture of the object-side surface of the first lens, SD31 represents half of a clear aperture of the object-side surface of the third lens.

14. The lens module of claim 10, wherein the optical system satisfies the following expression:

|f/f4|≤0.30;
wherein f represents an effective focal length of the optical system, f4 represents an effective focal length of the fourth lens.

15. The lens module of claim 10, wherein the optical system satisfies the following expression:

|f6/R61|<10.0;
wherein f6 represents an effective focal length of the sixth lens, R61 represents a radius of curvature of the object-side surface of the sixth lens near the optical axis.

16. The lens module of claim 10, wherein the optical system satisfies the following expression:
0.50≤CT4+T45/CT5+CT6≤0.81;
wherein CT4 represents a thickness of the fourth lens on the optical axis, T45 represents a distance from the fourth lens to the fifth lens on the optical axis, CT5 represents a thickness of the fifth lens on the optical axis, and CT6 represents a thickness of the sixth lens on the optical axis.

17. The lens module of claim 10, wherein the optical system satisfies the following expression:
0.22≤|R71−R72|/|R71+R72|<0.8;
wherein R71 represents a radius of curvature of the object-side surface of the seventh lens near the optical axis, R72 represents a radius of curvature of the image-side surface of the seventh lens near the optical axis.

18. The lens module of claim 10, wherein the optical system satisfies the following expression:
R22/R31<1.3;
wherein R22 represents a radius of curvature of the image-side surface of the second lens near the optical axis, R31 represents a radius of curvature of the object-side surface of the third lens near the optical axis.

19. An electronic device, comprising:
a housing; and
a lens module received in the housing, comprising:
a lens barrel; and
an optical system comprising, in order from an object side to an image side along an optical axis:
a first lens with a positive refractive power, wherein the first lens has an object-side surface which is convex, and an image-side surface which is concave near the optical axis;
a second lens with a negative refractive power, wherein the second lens has an object-side surface which is convex near the optical axis, and an image-side surface which is concave;
a third lens with a positive refractive power, wherein the third lens has an object-side surface which is convex;
a fourth lens with a refractive power, wherein the fourth lens has an object-side surface which is convex near the optical axis, and an image-side surface which is convex near the optical axis;
a fifth lens with a refractive power, wherein the fifth lens has an object-side surface which is concave near a periphery of the object-side surface of the fifth lens, and an image-side surface which is convex near a periphery of the image-side surface of the fifth lens, and wherein both the object-side surface and the image-side surface of the fifth lens are aspherical;
a sixth lens with a refractive power, wherein the sixth lens has an object-side surface which is concave near a periphery of the object-side surface of the sixth lens, and an image-side surface which is convex near a periphery of the image-side surface of the the sixth lens, and wherein both the object-side surface and the image-side surface of the sixth lens are aspherical, at least one of the object-side surface and the image-side surface of the sixth lens has at least one inflection point; and
a seventh lens with a negative refractive power, wherein the seventh lens has an object-side surface which is convex near the optical axis, and an image-side surface which is concave near the optical axis, and wherein both the object-side surface and the image-side surface of the seventh lens are aspherical, at least one of the object-side; surface and the image-side surface of the seventh lens has at least one inflection point;
wherein the first to seventh lenses of the optical system are received in the lens barrel.

20. The electronic device of claim 19, wherein the optical system satisfies the following expression:
1.4≤f/EPD≤2.0;
wherein f represents an effective focal length of the optical system, EPD represents an entrance pupil diameter of the optical system.
